(19) United States
(12) Patent Application Publication
(10) Pub. No.: US 2014/0118834 A1
(43) Pub. Date: May 1, 2014

(54) Compound-Eye Unit

(71) Applicants: Naoyuki Inoue, Hino-shi (JP); Takashi Kawasaki, Koganei-shi (JP); Susumu Yamaguchi, Hachioji-shi (JP)

(72) Inventors: Naoyuki Inoue, Hino-shi (JP); Takashi Kawasaki, Koganei-shi (JP); Susumu Yamaguchi, Hachioji-shi (JP)

(21) Appl. No.: 14/123,507

(22) PCT Filed: May 24, 2012
(86) PCT No.: PCT/JP2012/063289

§ 371 Date: Dec. 2, 2013

(30) Foreign Application Priority Data
Jun. 1, 2011 (JP) 2011-123600
Jun. 1, 2011 (JP) 2011-123601

(51) Int. Cl. G02B 3/00

(52) U.S. Cl. CPC G02B 3/0075; G02B 3/0031
USPC 359/619

(57) ABSTRACT

A highly accurate compound-eye unit is provided, which can assemble a compound-eye lens member to a lens holder with high positional accuracy even when using the compound-eye lens member that is unsatisfactory in dimensional accuracy of an external shape. A highly accurate compound-eye unit is provided, which can assemble a light shielding member having a plurality of apertures with high positional accuracy. A distance W2 between centers of apertures AP2, AP3 is smaller than a distance W1 between optical axes of convex lens units PL2, PL3, and hence, as illustrated in FIG. 13, when a lens member IM3 is made to approach a lens holder LH along an optical-axis direction, optical surfaces or external portions of peripheral surfaces of convex lens units PL2, PL3 abut on edge portions of the apertures AP2, AP3 at two points P, Q, and a flat surface FP abuts on an abutting portion CT. At this time, the flat surface FP abuts on the abutting portion CT, whereby the lens member IM3 and the lens holder LH are positioned in the optical-axis direction. On the other hand, the optical surfaces or the peripheral surfaces of the convex lens units PL2, PL3 abut on the apertures AP2, AP3, thereby attaining the positioning in an optical-axis orthogonal direction and the positioning around a Z-axis.

### TECHNICAL FIELD

The present invention relates to a compound-eye unit suitable for use of a compound-eye image capturing apparatus.

### BACKGROUND ART

Over the recent years, a compound-eye image capturing apparatus has been developed as a small-sized and thin camera module mounted in a mobile phone, a personal computer, etc. The compound-eye image capturing apparatus is configured to include, roughly, a compound-eye unit in which a plurality of lens unit is disposed, image capturing elements for capturing a plurality of images formed by lens units of the compound-eye unit and an image restructuring circuit that restructures plural frames of images captured by the image capturing elements into one frame of image.

A technology related to the compound-eye image capturing apparatus is exemplified such as a technology of separating a wide-angle subject area into some regions, providing a plurality of image capturing lenses corresponding to the respective regions and reproducing the wide-angle subject area by connecting together the images obtained by the respective lenses through image processing, and a technology of providing, in a visible light communication system, a plurality of bandpass filters each having a different transmission wavelength band and image capturing lenses corresponding to the respective filters, and transforming the images obtained by the individual lenses into a communication data format.

PTL1 discloses the compound-eye image capturing apparatus. A compound-eye lens member used for this compound-eye image capturing apparatus is manufactured by injection molding. In the compound-eye lens member manufactured by the injection molding, an external shape is formed by die assemblies and therefore has generally a characteristic of its being good in terms of dimensional accuracy. Hence, a positioning portion of parts attached to the compound-eye lens member can be formed to a benchmark of the external shape with high dimensional accuracy, and, for instance, a stop and a holder can be assembled with high positional precision.

### CITATION LIST

### Patent Literature

PTL1: Japanese Patent Application Laid-Open Publication No. 2009-217029

### SUMMARY OF INVENTION

### Technical Problem

On the other hand, another manufacturing method of the compound-eye lens member is exemplified by wafer level optics (WLO) in which a glass mold (GM) lens molded by pressing a molten glass with die assemblies and a multiplicity of lenses are formed batchwise on a substrate on a wafer-size basis, and thereafter the individual lenses are acquired by dicing this substrate. This manufacturing method is capable of manufacturing the multiplicity of lenses at one time and therefore has a merit of improving productivity of the compound-eye lens member.

When the lens member having the plurality of lens units is formed by such a manufacturing method, however, there arises a problem of how the respective lens units are positioned with respect to the plurality of image capturing elements with the high accuracy. A specific description thereof will be made. To begin with, a lens holder can be positioned with respect to the image capturing elements with the high precision, and hence it may be acceptable if the lens member and the lens holder are highly accurately fitted. In the case of the GM lens described above, however, the external shape of the GM lens is not formed by the die assemblies but formed on a manufacturer basis, and therefore the accuracy of the external shape cannot be expected. Consequently, on the occasion of assembling this GM lens into the lens holder, a problem arises as to what benchmark the positioning is done based on. Furthermore, in the case of the WLO described above also, the individual lens acquired by dicing is rectangular in external shape and is comparatively unsatisfactory in dimensional accuracy of the external shape, resulting in the similar positioning problem. Namely, it follows that the problem occurs when the lens member and the lens holder cannot be fitted based on the benchmark of the external shape. Especially, the compound-eye image capturing apparatus, unlike a single-eye image capturing apparatus, requires rotational positioning around an optical axis, and hence the positioning problem is of importance.

Still further, when forming the lens member including the plurality of lens units by the manufacturing method such as this, there exists a problem of how a light shielding member for restraining a ghost from occurring is positioned with respect to the respective lens units with the high accuracy. To be specific, in the case of the GM lens described above, the external shape of the GM lens is not formed by the die assemblies but formed on the manufacturer basis, and the dimensional accuracy of the external shape cannot be expected, so that there arises the problem of what benchmark the light shielding member is positioned based on. Moreover, in the case of the WLO described above also, the individual lens obtained by dicing takes the rectangular external shape and is comparatively unsatisfactory in dimensional accuracy of the external shape, resulting in the similar positioning problem. Particularly, the compound-eye image capturing apparatus, unlike the single-eye image capturing apparatus, requires the rotational positioning around the optical axis, and hence the positioning problem is of importance.

It is an object of the present invention to provide a highly accurate compound-eye unit capable of assembling compound-eye lens units to a lens holder with high positional accuracy even when using the compound-eye lens units that are unsatisfactory in dimensional accuracy of an external shape.

It is another object of the present invention to provide a highly accurate compound-eye unit capable of assembling a light shielding member having a plurality of apertures with high positional accuracy.

### Solution to Problem

A compound-eye unit according to claim 1 includes: a lens member being molded by die assemblies and formed with a plurality of lens units in a predetermined positional relationship; and a lens holder being provided with a plurality of apertures corresponding to the lens units, wherein a surface of the lens member including the plurality of lens units molded by the die assemblies is set as a reference surface of the lens member that specifies at least one of an optical-axis direction relative position, an optical-axis orthogonal direction relative position and a rotating direction relative position between the lens member and the lens holder.

According to the present invention, the surface of the lens member including the plurality of lens units molded by the die assemblies is set as the reference surface of the lens member that specifies at least one of the optical-axis direction relative position, the optical-axis orthogonal direction relative position and the rotating direction relative position between the lens member and the lens holder. Therefore, even if an external shape of the lens member is not formed with high accuracy, the positioning with respect to the lens holder can be done with the high precision. Note that the surface of the lens member including the plurality of lens units indicates the surface extending along peripheries of the lens units molded by the die assemblies but does not embrace an external peripheral surface of the lens member in the optical-axis orthogonal direction that is not formed by the die assemblies.

The compound-eye unit according to claim 2 is, in the invention according to claim 1, characterized in that curved surfaces of the two of the plurality of lens units are set as the reference surfaces. The curved surfaces of the lens units are formed by transferring from the die assemblies with the high accuracy and are therefore suitable for being used as the reference surfaces. The convex lens units are to have optical surfaces protruding on the side of the lens holder.

The compound-eye unit according to claim 3 is, in the invention according to claim 2, characterized in that the two convex lens units abut on the apertures of the lens holder in such a way that sides, distant from each other, of the optical surfaces or sides, distant from each other, of the peripheral surfaces are set as the reference surfaces. With this contrivance, the lens member and the lens holder can be positioned with the high accuracy. The “peripheral surface” implies a portion taking a shape of the curved surface subsequent to the optical surface outwardly of the optical surface.

The compound-eye unit according to claim 4 is, in the invention according to claim 2, characterized in that the two convex lens units abut on the apertures of the lens holder in such a way that sides, proximal to each other, of the optical surfaces or sides, proximal to each other, of the peripheral surfaces are set as the reference surfaces. With this contrivance, the lens member and the lens holder can be positioned with the high accuracy.

The compound-eye unit according to claim 5 is, in the invention according to claim 3 or 4, characterized in that the optical surfaces or the peripheral surfaces of the lens units other than the two convex lens units are prevented from abutting on the apertures of the lens holder. The surfaces other than the reference surface are prevented from abutting on the apertures, whereby the lens member and the lens holder can be positioned with the high precision.

The compound-eye unit according 6 is, in the invention according to any one of claims 2 to 5, characterized in that the two convex lens units are the lens units of which optical axes are distanced to the greatest degree within the plurality of lens units. With this contrivance, the lens member and the lens holder can be positioned with the higher accuracy.

The compound-eye unit according to 7 is, in the invention according to any one of claims 1 to 6, characterized in that the lens member includes one or more ribs on the surface of the lens member molded by die assemblies, and, with the rib surface serving as the reference surface, the lens member is abutted on a part of the lens holder. The rib is formed by the die assemblies, and hence a relative position thereto is highly accurately set. The surface of the rib is set as the reference surface, whereby the lens member and the lens holder can be positioned with the high accuracy.

The compound-eye unit according to claim 8 is, in the invention according to any one of claims 1 to 7, characterized in that the lens member includes peripheral surfaces surrounding the plurality of lens units molded by the die assemblies, and, with the peripheral surfaces serving as the reference surfaces, the lens member is abutted on a part of the lens holder. The peripheral surface is formed by the die assemblies, and therefore the relative position thereto is highly accurately set. The peripheral surface is set as the reference surface, whereby the lens member and the lens holder can be positioned with the high accuracy. Herein, the “peripheral surface” surrounds the plurality of lens units and embraces a surface directed to the optical-axis.

The compound-eye unit according to claim 9 is, in the invention according to any one of claims 1 to 8, characterized in that the lens member includes a stepped surface defined as the surface of the lens member molded by the die assemblies and formed along peripheries of the plurality of lens units, and, with the stepped surface serving as the reference surface, the lens member is abutted on a part of the lens holder. The stepped surface is formed by the die assemblies, and hence the relative position to the lens unit is highly accurately set. The stepped surface is set as the reference surface, whereby the lens member and the lens holder can be positioned with the high accuracy.

The compound-eye unit according to claim 10 is, in the invention according to any one of claims 1 to 9, characterized in that the die assemblies molding the lens member do not restrict an external periphery of the lens member when molding, and the lens member is a glass. When the molding is carried out by using the die assemblies such as this, the effects of the present invention are effectively exhibited in particular.

The compound-eye unit according to claim 11 is, in the invention according to any one of claims 1 to 10, characterized in that the lens member includes a substrate, and the lens units are formed on at least one surface of the substrate. The present invention is effective also in the thus-manufactured lens member.

The compound-eye unit according to claim 12 is, in the invention according to any one of claims 1 to 11, characterized in that the lens member is acquired by forming a multiplicity of lens units on one substrate and thereafter cutting out the substrate so as to embrace a predetermined number of lens units. The present invention is effective also in the thus-manufactured lens member.

The compound-eye unit according to claim 13 is, in the invention according to any one of claims 1 to 12, characterized in that a surface molded by the die assemblies is set as the reference surface for positioning a light shielding member disposed adjacent to the lens unit. With this contrivance, the light shielding member can be positioned with respect to the lens units with the high accuracy.

The compound-eye unit according to claim 14 is, in the invention according to any one of claims 1 to 13, characterized in that the surface molded by the die assemblies is set as the reference surface for positioning an image capturing element. With this contrivance, the image capturing element can be positioned with respect to the lens units with the high accuracy.

A compound-eye unit according to claim 15 includes: a lens member being molded by die assemblies and formed with a plurality of lens units in a predetermined positional relationship; and a light shielding member being provided with a plurality of apertures corresponding to the lens units, wherein a surface of the lens member including the plurality of lens units molded by the die assemblies is set as a reference surface of the lens member that specifies at least one of an optical-axis direction relative position, an optical-axis orthogonal direction relative position and a rotating direction relative position between the lens member and the light shielding member.

According to the present invention, the surface of the lens member including the plurality of lens units molded by the die assemblies is set as the reference surface of the lens member that specifies at least one of the optical-axis direction relative position, the optical-axis orthogonal direction relative position and the rotating direction relative position between the lens member and the light shielding member. Therefore, for example, even if an external shape of the lens member is not formed with the high accuracy, the positioning with respect to the light shielding member can be done with the high precision. Note that the surface of the lens member including the plurality of lens units indicates the surface extending along the peripheries of the lens units molded by the die assemblies but does not embrace the external peripheral surface of the lens member in the optical-axis orthogonal direction that is not formed by the die assemblies.

The compound-eye unit according to claim 16 is, in the invention according to claim 15, characterized in that curved surfaces of the two of the plurality of lens units are set as the reference surfaces. The curved surfaces of the lens units are formed by transferring from the die assemblies with the high accuracy and are therefore suitable for being used as the reference surfaces. The “convex lens unit” represents the lens unit of which the optical surface protrudes on the side of the light shielding member.

The compound-eye unit according to claim 17 is, in the invention according to claim 16, characterized in that the two convex lens units abut on the apertures of the light shielding member in such a way that sides, distant from each other, of the optical surfaces or sides, distant from each other, of the peripheral surfaces are set as the reference surfaces. With this contrivance, the light shielding member can be positioned with respect to the lens member with the high accuracy. The “peripheral surface” represents a portion taking a shape of the curved surface subsequent to the optical surface outwardly of the optical surface.

The compound-eye unit according to claim 18 is, in the invention according to claim 16, characterized in that the two convex lens units abut on the apertures of the light shielding member in such a way that sides, proximal to each other, of the optical surfaces or sides, proximal to each other, of the peripheral surfaces are set as the reference surfaces. With this contrivance, the light shielding member can be positioned with respect to the lens member with the high accuracy.

The compound-eye unit according to claim 19 is, in the invention according to claim 17 or 18, characterized in that the optical surfaces or the peripheral surfaces of the lens units other than the two convex lens units are prevented from abutting on the apertures of the light shielding member. The surfaces other than the reference surface are prevented from abutting, whereby the light shielding member can be positioned with respect to the lens member with the high accuracy.

The compound-eye unit according to claim 20 is, in the invention according to any one of claims 16 to 19, characterized in that the two convex lens units are the lens units of which optical axes are distanced to the greatest degree within the plurality of lens units. With this contrivance, the light shielding member can be positioned with respect to the lens member with the high accuracy.

The compound-eye unit according to claim 21 is, in the invention according to claim 15, characterized in that curved surfaces of two concave lens units of the plurality of lens units are set as the reference surfaces, at least a part of the aperture of the light shielding member is provided with a protruded portion, and the protruded portion is abutted on the reference surface. According to such a configuration, even when the lens units are concave lens units also, the positioning can be performed with respect to the light shielding member with the high accuracy. The “concave lens unit” represents a lens unit of which the optical surface on the side of the light shielding member is recessed. Note that the “protruded portion” embraces all the projections for being caught by the concave lens unit. For example, in the case of press parts, the projected portion can be realized by a means such as a bending work as in an embodiment that will be described later on. On the other hand, the projected portion can be also formed by resin molding and a lathe work.

The compound-eye unit according to claim 22 is, in the invention according to claim 15, characterized in that a stepped surface is provided on the surface of the lens member formed by the die assemblies outwardly of the lens units and is set as the reference surface. According to such a configuration, even when the lens units are the concave lens units also, the positioning can be performed with respect to the light shielding member with the high accuracy.

The compound-eye unit according to claim 23 is, in the invention according to claim 15, characterized in that a projection is provided on the surface of the lens member formed by the die assemblies outwardly of the lens units, and a side surface of the projection is set as the reference surface. According to such a configuration, even when the lens units are the concave lens units also, the positioning can be performed with respect to the light shielding member with the high accuracy.

The compound-eye unit according to claim 24 is, in the invention according to any one of claims 15 to 23, characterized in that the lens member includes a rib on the surface of the lens member molded by the die assemblies, and, with the rib surface serving as the reference surface, the lens member is abutted on a part of the light shielding member. With this contrivance, the light shielding member can be positioned with respect to the lens member with the high accuracy.

The compound-eye unit according to claim 25 is, in the invention according to any one of claims 15-24, characterized in that the light shielding member is disposed between the plural lens members. The light shielding member may be, however, provided closest to an image side or an object side in single or plural lens members.

The compound-eye unit according to claim 26 is, in the invention according to any one of claims 15 to 25, characterized in that the die assemblies molding the lens member do not restrict a periphery of the lens member, and the lens member is a glass. For instance, when the molding is conducted by using such die assemblies, the effects of the present invention are effectively exhibited in particular.

The compound-eye unit according to claim 27 is, in the invention according to any one of claims 15 to 26, characterized in that the surface molded by the die assemblies is set as the reference surface for positioning an image capturing element. With this contrivance, the image capturing element can be positioned with respect to the lens units with the high accuracy.

The compound-eye unit according to claim 28 is, in the invention according to any one of claims 1 to 27, characterized in that the lens member includes a substrate, and the lens units are formed on at least one surface of the substrate. The present invention is effective also in the thus-manufactured lens member.

### Advantageous Effects of Invention

According to the present invention, it is feasible to provide the highly accurate compound-eye unit capable of attaining the assembling with respect to the lens holder with the high precision even when using the compound-eye lens member exhibiting poor accuracy of an external dimension.

Moreover, according to the present invention, it is possible to provide the highly accurate compound-eye unit capable of assembling the light shielding member having the plurality of apertures with the high precision.

### BRIEF DESCRIPTION OF DRAWINGS

FIG. 1 is a view illustrating a molding step of an image capturing lens by use of die assemblies in a first embodiment.

FIG. 2 is a view illustrating the molding step of the image capturing lens by use of the die assemblies.

FIG. 3 is a view illustrating the molding step of the image capturing lens by use of the die assemblies.

FIG. 4 is a perspective view of a surface side of a first glass lens array IM1.

FIG. 5 is a perspective view of an underside of the first glass lens array IM1.

FIG. 6 is a perspective view of a surface side of a second glass lens array IM2.

FIG. 7 is a perspective view of an underside of the second glass lens array IM2.

FIG. 8 is a view illustrating a part of a jig JZ that holds the undersurface of the first glass lens array IM1 or the second glass lens array IM2.

FIG. 9 is a view illustrating a step of forming the third glass lens array IM3.

FIG. 10 is a view illustrating the step of forming the third glass lens array IM3.

FIG. 11 is an exploded view of a compound-eye image capturing apparatus.

FIG. 12 is a view illustrating a positional relationship between convex lens units PL1-PL4 (depicted by solid lines) of the lens member IM3 and apertures AP1-AP4 (depicted by dotted lines) of a lens holder LH.

FIG. 13 is a view of a configuration cut off along a line XIII-XIII in FIG. 12 as viewed in an arrow direction.

FIG. 14 is a view illustrating a modified example of the aperture.

FIG. 15 is a view illustrating another positional relationship between the convex lens units PL1-PL4 (depicted by the solid lines) of the lens member IM3 and the apertures AP1-AP4 (depicted by the dotted lines) of the lens holder LH.

FIG. 16 is a view illustrating still another positional relationship between the convex lens units PL1-PL4 (depicted by the solid lines) of the lens member IM3 and the apertures AP1-AP4 (depicted by the dotted lines) of the lens holder LH.

FIG. 17 is a perspective view illustrating a lens member IM3 according to another working example.

FIG. 18 is a perspective view illustrating the lens member IM3 according to still another working example.

FIG. 19 is a perspective view illustrating the lens member IM3 according to yet another working example.

FIG. 20 is a perspective view illustrating the lens member IM3 according to yet another working example.

FIG. 21 is a perspective view illustrating the lens member IM3 according to a further working example.

FIG. 22 is a perspective view illustrating the lens member IM3 according to a still further working example.

FIG. 23 is an exploded view of the compound-eye image capturing apparatus according to another working example.

FIG. 24 is a view illustrating a part of the manufacturing step of the lens member according to another working example.

FIG. 25 is a view illustrating a step of forming a third glass lens array IM3 in a second embodiment.

FIG. 26 is a view illustrating the step of forming the third glass lens array IM3.

FIG. 27 is an exploded view of the compound-eye image capturing apparatus.

FIG. 28 is an exploded view of the compound-eye image capturing apparatus.

FIG. 29 is a view illustrating a positional relationship between the lens units PL1-PL4 (depicted by the solid lines) of the lens member IM3 and the apertures AP1-AP4 (depicted by the dotted lines) of the lens holder LH.

FIG. 30 is a view of a configuration cut off along a line XXX-XXX in FIG. 29 as viewed in an arrow direction.

FIG. 31 is a view illustrating a modified example of the aperture.

FIG. 32 is a view illustrating another positional relationship between the lens units PL1-PL4 (depicted by the solid lines) of the lens member IM3 and the apertures AP1-AP4 (depicted by the dotted lines) of the lens holder LH.

FIG. 33 is a view illustrating still another positional relationship between the lens units PL1-PL4 (depicted by the solid lines) of the lens member IM3 and the apertures AP1-AP4 (depicted by the dotted lines) of the lens holder LH.

FIG. 34 is a perspective view illustrating the lens member IM3 and the light shielding member SH according to another working example.

FIG. 35 is a perspective view illustrating the lens member IM3 and the light shielding member SH according to still another working example.

FIG. 36 is a sectional view of the lens member IM1 according to another working example.

FIG. 37 is a perspective view illustrating the lens member IM3 and the light shielding member SH according to another working example.

FIG. 38 is a sectional view of the lens member IM1 according to still another working example.

FIG. 39 is an exploded sectional view of the lens member IM3 according to still another working example.

FIG. 40 is a sectional view of a portion in the vicinity of the aperture of the light shielding member SH.

FIG. 41 is an exploded view of the compound-eye image capturing apparatus according to still another working example.

FIG. 42 is a sectional view similar to FIG. 30 according to yet another working example.

### DESCRIPTION OF EMBODIMENTS

### First Embodiment

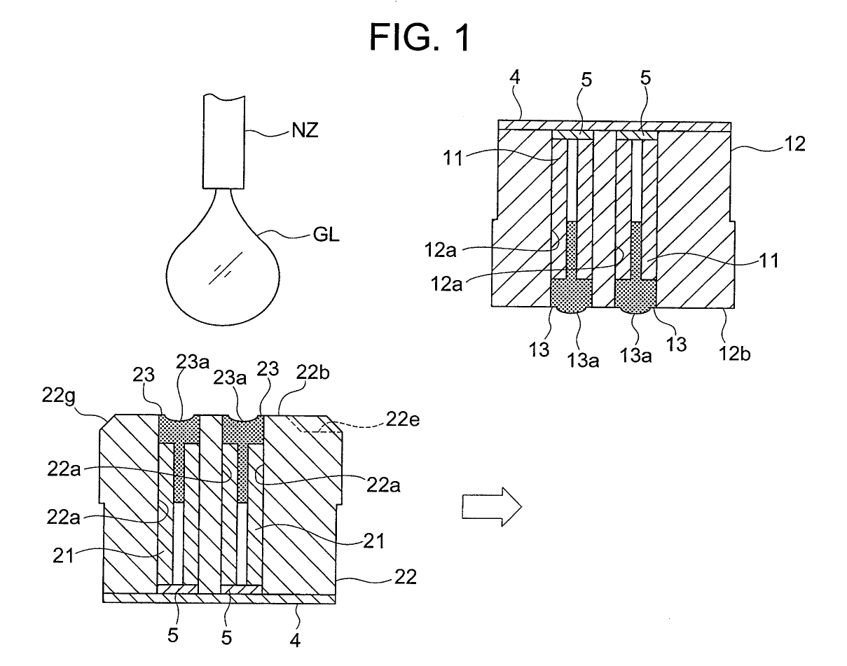

A first embodiment of the present invention will hereinafter be described with reference to FIGS. 1-24.

To begin with, a description of how an image capturing lens is manufactured will be made by use of FIGS. 1-3. Note that a base plate 4 covers end portions of die assemblies 12, 22, and spacers 5 serve to adjust protruding quantities of cores 13, 23 throughout the drawings. In FIG. 1, the lower die assembly 22 is configured such that at first, core support members 21, of which upper edges are fitted with the cores 23, are assembled into four apertures 22a. The lower die assembly 22 is positioned under a platinum nozzle NZ communicating with a storage portion (unillustrated) containing a glass molten by heating. Liquid droplets of a molten glass GL are batchwise dropped from the platinum nozzle NZ onto an upper surface 22b toward a position equally distanced from a plurality of molding surfaces. In such a state, a viscosity of the glass GL is low, and hence the dropped glass GL spreads over the upper surface 22b and easily permeates into a transfer surface 23a of the core 23, thus transferring a shape thereof and a shape of groove 22e as well with high accuracy.

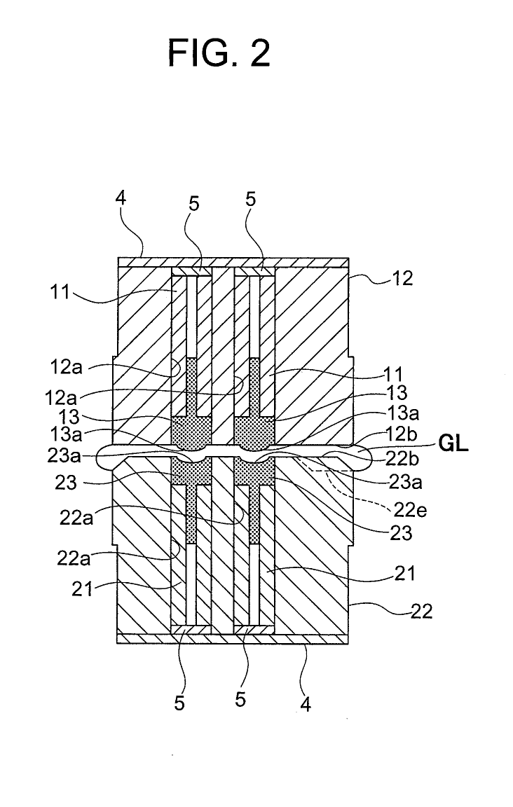

Subsequently, before the glass GL is cooled off, the lower die assembly 22 is made to approach a face-to-face position under the upper die assembly 12 configured such that core support members 11, of which lower edges are fitted with the cores 13, are assembled into four apertures 12a. Then, the lower die assembly 22 is aligned with the upper die assembly 12 by use of an unillustrated positioning guide. Further, as illustrated in FIG. 2, molding is carried out in a way that gets the upper die assembly 12 and the lower die assembly 22 close together. A shape (a convex shape is illustrated herein) of a transfer surface 13a of the core 13 is thereby transferred. Note that a shallow circular stepped portion is formed along a periphery of the transfer surface 13a, and hence a shape of this circular stepped portion is also simultaneously transferred. At this time, the glass GL is cooled off while holding the upper die assembly 12 and the lower die assembly 22 so that a lower surface 12b of the upper die assembly 12 and an upper surface 22b of the lower die assembly 22 are spaced away at a predetermined distance. The glass GL is solidified in a state of flowing around to cover a tapered portion 22g. Namely, the die assembles 12, 22 do not restrict an extension of the glass GL without getting contiguous to the periphery of the glass GL during a molding process.

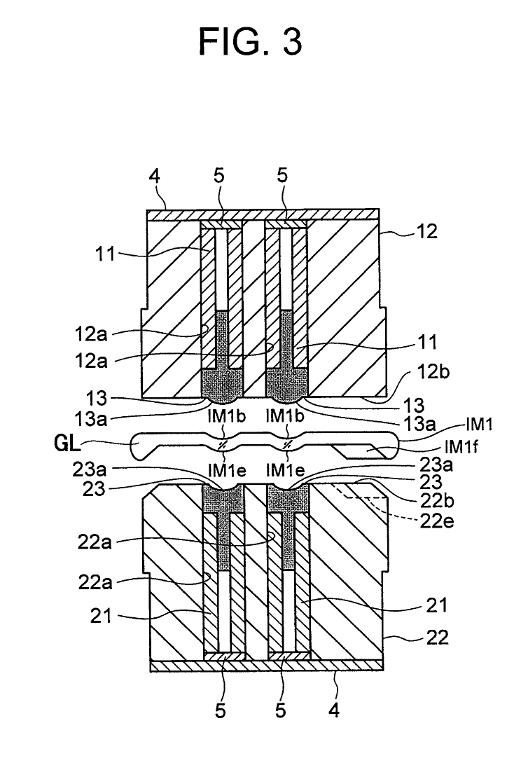

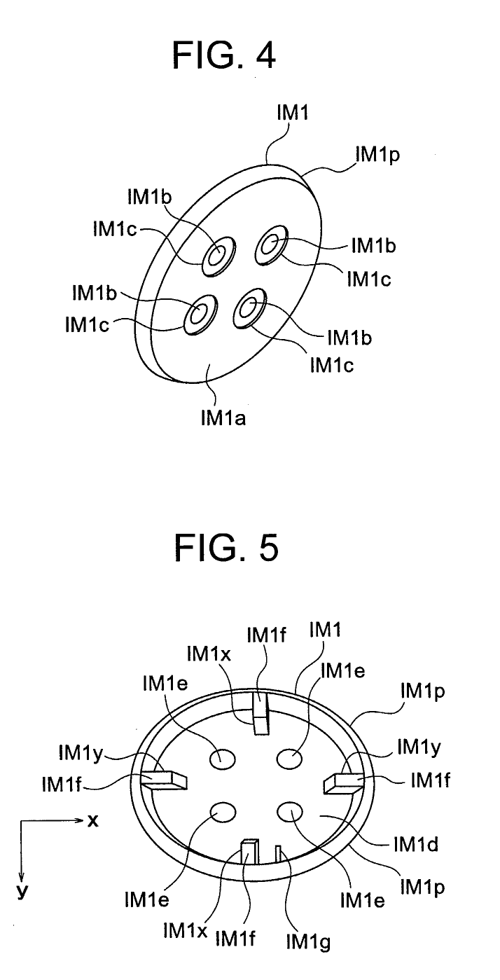

Thereafter, as depicted in FIG. 3, the glass GL is extracted by separating the upper die assembly 12 and the lower die assembly 22 from each other, thereby forming a first glass lens array IM1. A second glass lens array IM2 can be likewise formed by another set of die assemblies. FIG. 4 is a perspective view of a surface side of the first glass lens array IM1, and FIG. 5 is a perspective view of an underside thereof. Note that other than the glass array forming method described above, there is another method of transfer-forming the lens units of the die assemblies by pressing the solid-state glass with the die assemblies while heating the glass.

As illustrated in FIGS. 4 and 5, the first glass lens array IM1 taking a disc shape on the whole includes a surface IM1a as a highly accurate flat surface that is transfer-molded by the lower surface 12b of the upper die assembly 12, four concave optical surfaces IM1b that are transfer-molded onto the surface IM1a by the transfer surface 13a, and a shallow circular groove IM1c that is transferred by the circular stepped portion along the periphery thereof. This circular groove IM1c can be used for disposing a light shielding member.

Moreover, the first glass lens array IM1 includes an undersurface IM1d as a highly accurate flat surface that is transfer-molded by the upper surface 22b of the lower die assembly 22, four convex optical surfaces IM1e that are transfer-molded onto the undersurface IM1d by the transfer surface 23a, and a convex portion IM1f that is transfer-molded by the groove 22e. Note that a convex mark IM1g indicating a direction may concurrently be formed. The optical surface IM1b and the optical surface IM1e configure a first lens unit L1. It is to be noted that the convex portion IM1f is configured by including a first reference surface portion IM1x disposed in parallel to an optical axis of the first lens unit L1 and in a face-to-face relationship with an x-direction, and a second reference surface portion IM1y disposed in the face-to-face relationship with a y-direction. The undersurface IM1d configures a first gradient reference surface, and a first shift reference surface is configured by including the first reference surface portion IM1x and the second reference surface portion IM1y. A side surface portion IM1p as a surface, directed perpendicularly to the optical axis, of the first glass lens array IM1 is not formed by the upper and lower die assemblies 12 and 22 but formed on a manufacturer basis.

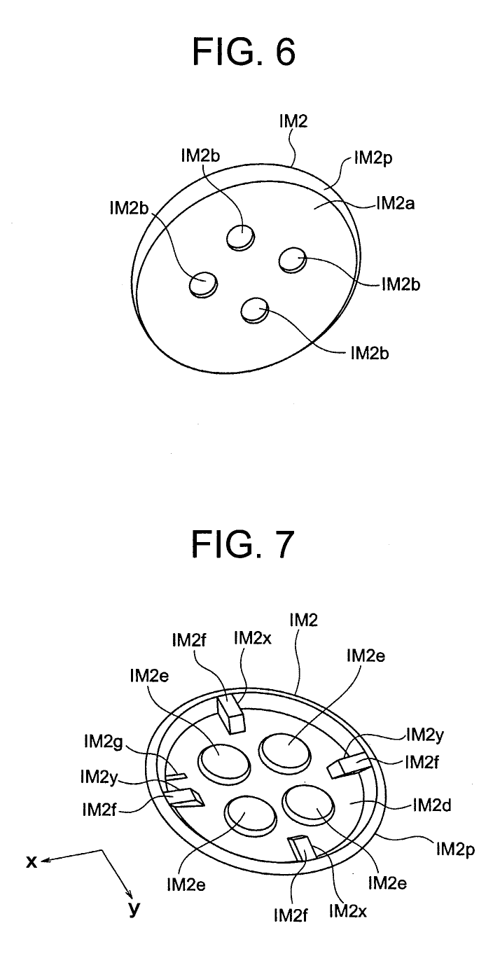

FIG. 6 is a perspective view of the surface side of a second glass lens array IM2 which is transfer-molded by another set of die assemblies, and FIG. 7 is a perspective view of the underside thereof. The second glass lens array IM2 molded in the same manner as the first glass lens array IM1 is molded takes, as illustrated in FIGS. 6 and 7, the disc shape on the whole, and includes a surface IM2a as a highly accurate flat surface that is transfer-molded by the unillustrated die assemblies and four concave optical surfaces IM2b that are transfer-molded onto the surface IM2a. Note that the second glass lens array IM2, though omitting a shallow groove formed for accommodating a light shielding member SH, which will be described later on, along the periphery of the optical surface IM2b, may also be provided with this groove.

Moreover, the second glass lens array IM2 includes an undersurface IM2d as a highly accurate flat surface that is transfer-molded by an unillustrated set of die assemblies, four convex optical surfaces IM2e that are transfer-molded onto the undersurface IM2d, and a convex portion IM2f. Note that a convex mark IM2g indicating a direction may concurrently be formed. The optical surface IM2b and the optical surface IM2e configure a second lens unit L2. It is to be noted that the convex portion IM2f includes a third reference surface portion IM2x disposed in parallel to an optical axis of the second lens unit L2 and in the face-to-face relationship with the x-direction, and a fourth reference surface portion IM2y disposed in the face-to-face relationship with the y-direction. The undersurface IM2d configures a second gradient reference surface, and a second shift reference surface is configured by including the third reference surface portion IM2x and the fourth reference surface portion IM2y. Note that a side surface portion IM2p as a surface, directed perpendicularly to the optical axis, of the second glass lens array IM2 is not formed by the upper and lower die assemblies 12 and 22 but formed on the manufacturer basis.

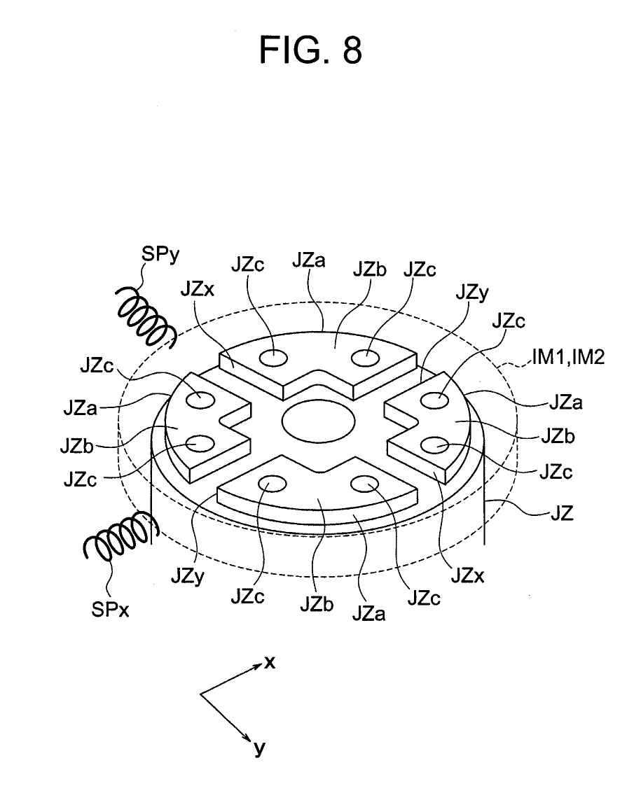

Described next is a step of forming a third glass lens array IM3 by bonding the first glass lens array IM1 and the second glass lens array IM2 together. FIG. 8 is a view illustrating a part of a jig JZ for holding the undersurface of the first glass lens array IM1 or the second glass lens array IM2. In FIG. 8, a circular end surface of the jig JZ is notched in cruciform. To be specific, four pieces of land portions JZa having a uniform height are formed on the end surface of the jig JZ, and upper surfaces JZb thereof are flat and are formed with suction holes JZc each communicating with an unillustrated negative pressure source. Each land portion JZa includes a reference holding surface JZx disposed in a face-to-face relationship with the x-direction and a reference holding surface JZy in a face-to-face relationship with the y-direction at the notched portions. Further, the jig JZ includes a spring SPx (simply illustrated) that biases the held glass lens array in the x-direction and a spring SPy (simply illustrated) that biases the held glass lens array in the y-direction.

An assumption herein is that the jig JZ holds the second glass lens array IM2 in a way that resists verticality. The upper surfaces JZb of the land portions JZa abut on the undersurface IM2d of the second glass lens array IM2 while sucking the air from the suction holes JZc with the jig JZ being inverted in top and bottom. At this time, the upper surfaces JZb of the land portions JZa of the jig JZ are tightly fitted to the undersurface IM2d, thereby enabling a gradient of the second glass lens array IM2 with respect to the jig JZ to be set with high accuracy. Further, the reference holding surfaces JZx of the land portions JZa are biased by the springs SPx and thereby abut on the third reference surface portions IM2x, while the reference holding surfaces JZy are biased by the springs SPy and thereby abut on the fourth reference surface portions IM2y. At this time, the mark IM2g becomes an index for indicating which position, a position of the third reference surface portion IM2x or a position of the fourth reference surface portion IM2y. The second glass lens array IM2 can be highly accurately positioned in the x- and y-directions with respect to the jig JZ. The third reference surface portion IM2x and the fourth reference surface portion IM2y are formed on both sides with the lens units being interposed therebetween, and hence the second glass lens array IM2 can be positioned with the high accuracy by effectively making use of a long span.

Similarly, the undersurface IM1d of the first glass lens array IM1 can be held by another jig JZ in a gradient direction and in the x- and y-directions. Namely, the upper surfaces JZb of the land portions JZa of the jig JZ are tightly fitted to the undersurface IM1d, thereby enabling the gradient of the first glass lens array IM1 with respect to the jig JZ to be set with the high accuracy. Further, the reference holding surfaces JZx of the land portions JZa are biased by the springs SPx and thereby abut on the first reference surface portions IM1x, while the reference holding surfaces JZy are biased by the springs SPy and thereby abut on the second reference surface portions IM1y. At this time, the (first) mark IM1g becomes an index for indicating which position, a position of the first reference surface portion IM1x or a position of the second reference surface portion IM1y. With the operations being thus done, relative positions of the two jigs JZ can be determined with the high accuracy, whereby the first glass lens array IM1 and the second glass lens array IM2 can be positioned with the high precision.

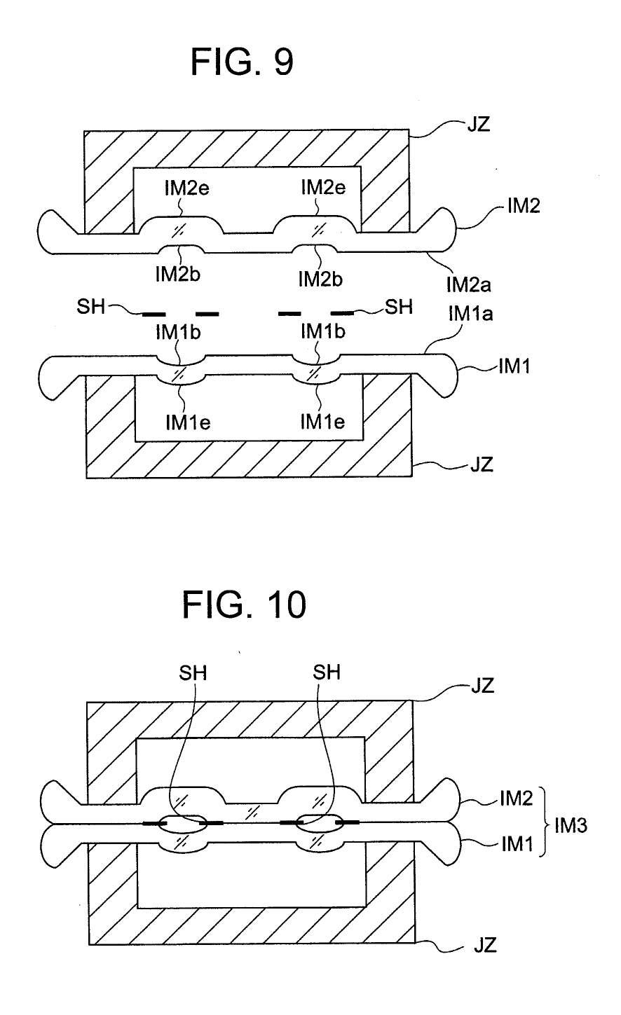

Further, as depicted in FIG. 9, the surface IM1a of the first glass lens array IM1 held by the jig JZ with the high accuracy as described above is set in the face-to-face relationship with the surface IM2a of the second glass lens array IM2 held by another jig JZ with the high precision, then four doughnut-plate type light shielding members SH are disposed between these two lens arrays, and a bonding agent is applied to the surface IM1a or IM2a of at least one of the first glass lens array IM1 and the second glass lens array IM2. Thereafter, as illustrated in FIG. 10, the surfaces IM1a and IM2a are tightly fitted together by relatively getting the two jigs JZ close to each other, and the bonding agent waits being solidified. With the bonding agent being solidified, the light shielding members SH are fitted into the circular grooves IM1c, thereby configuring the third glass lens array IM3 by the first glass lens array IM1 and the second glass lens array IM2 being bonded together.

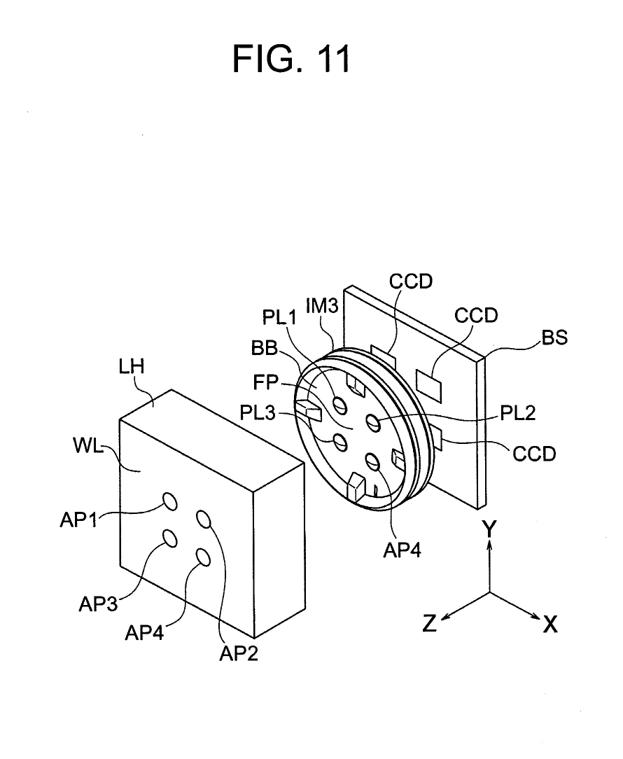

Thereafter, the upper jig JZ stops sucking, and the upper and lower jigs JZ are thus separated from each other, whereby the third glass lens array IM3 held by the lower jig JZ can be taken out. This third glass lens array IM3 is called a lens member, in which four pieces of convex lens units denoted by PL1-PL4 and taking the same shape are formed within the lens member IM3, and a base plate BB is a base provided with the convex lens units PL1-PL4 (see FIG. 11). Moreover, a flat surface FP of the base plate BB is defined as an optical-axis orthogonal surface extending along the peripheries of the convex lens units PL1-PL4. Optical surfaces or peripheral surfaces of the convex lens units PL1-PL4 and the flat surface FP are each formed with the high accuracy by the die assemblies and herein configure the reference surfaces.

Next, a method of assembling a compound-eye image capturing apparatus including compound-eye units according to the present embodiment will be described. FIG. 11 is an exploded view of the compound-eye image capturing apparatus. A lens holder LH taking a hollowed angular cylindrical shape is opened on an image side but closed as a wall WL on an object side as illustrated in FIG. 11. The wall WL is formed with four apertures AP1-AP4 and an abutting portion CT (see FIG. 13) protruding on the image side between the apertures. The apertures AP1-AP4 are disposed in (2-column×2-row) matrix corresponding to the convex lens units PL1-PL4 of the lens member IM3. After inserting, positioning and fixing the lens member IM3 within the lens holder LH, image capturing elements CCD (Charge Coupled Device) are disposed in (2-column×2-row) matrix corresponding to the convex lens units PL at an image-side open end of the lens holder LH on the base plate BB, and the compound-eye image capturing apparatus is configured by fitting this base plate BB. Herein, a Z-direction is defined as an optical-axis direction, while an X-direction and a Y-direction are defined as optical-axis orthogonal directions

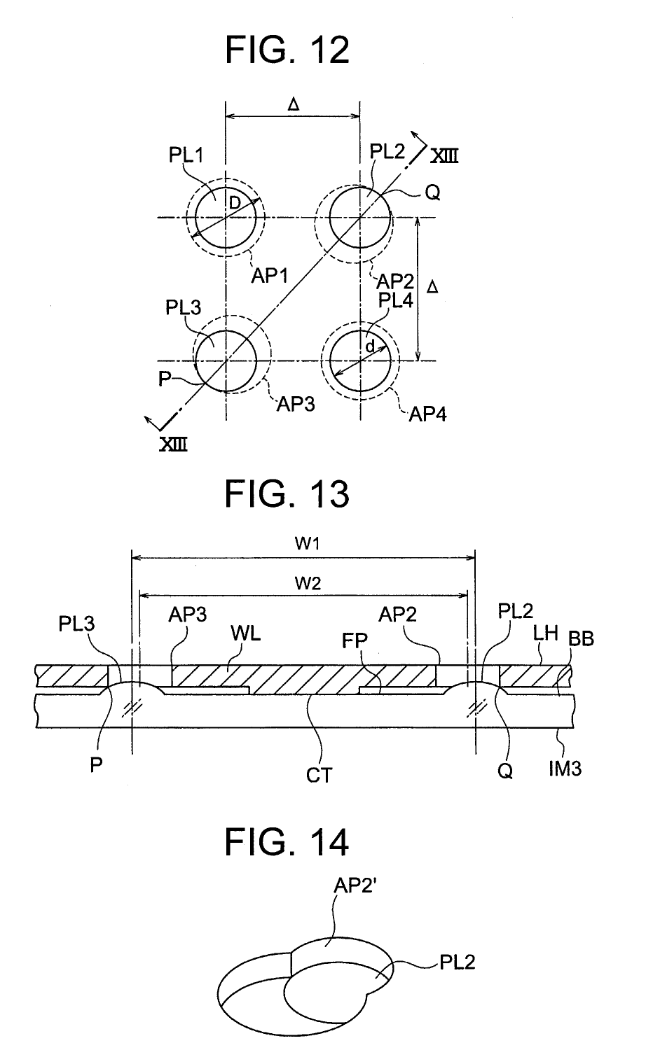

Next, a method of how the lens member IM3 is positioned to the lens holder LH will be described. FIG. 12 is a view showing a positional relationship between the convex lens units PL1-PL4 (depicted by solid lines) of the lens member IM3 and the apertures AP1-AP4 (depicted by dotted lines) of the lens holder LH as viewed from the Z-direction. As apparent from FIG. 12, there is a fixed interval Δ between the optical axes of the convex lens units PL1-PL4 adjacent to each other lengthwise and crosswise. On the other hand, an inside diameter D of each of the apertures AP1-AP4 is set larger than an outside diameter d of each of the convex lens units PL1-PL4, centers of the apertures AP1 and AP4 are coincident with the optical axes of the convex lens units PL1 and PL4, however, centers of the apertures AP2 and AP3 are shifted inward from the optical axes of the convex lens units PL2 and PL3.

FIG. 13 is a view of the configuration cut off along a line XIII-XIII as viewed in an arrow direction. A distance W2 between the centers of the apertures AP2, AP3 shifted inward is smaller than a distance W1 between the optical axes of the convex lens units PL2, PL3, and hence, when the lens member IM3 is made to approach the lens holder LH along the optical-axis direction, as illustrated in FIG. 13, the optical surfaces of the convex lens units PL2, PL3 or the external portions (distant portions) of the peripheral surfaces thereof abut on edge portions of the apertures AP2, AP3 at two points P, Q, while the flat surface FP abuts on an abutting portion CT. At this time, the flat surface FP abuts on the abutting portion CT, whereby the lens member IM3 and the lens holder LH are positioned in the optical-axis direction. On the other hand, the optical surfaces or the peripheral surfaces of the convex lens units PL2, PL3 abut on the apertures AP2, AP3, thereby attaining the positioning in the optical-axis orthogonal direction and the positioning about the Z-axis. Hereat, the convex lens units PL1, PL4 do not abut on the apertures AP1, AP4, and therefore it does not happen that the positioning is hindered. The lens member IM3 can be thereby positioned to the lens holder LH with the high precision. Incidentally, it is more preferable to get the peripheral surfaces rather than the optical surfaces to abut on the apertures.

FIG. 14 is a view depicting a modified example of the shape of the aperture. An aperture AP′2 illustrated in FIG. 14 takes a double semicircular shape formed by combining a large circle and a small circle, in which the positioning is attained by fitting the small circle of the aperture AP′2 to the convex lens unit PL2. The aperture may, without being limited to this shape, take a shape formed so as to abut the two straight sides forming an arbitrary aperture on the optical surfaces or the peripheral surfaces of the convex lens units.

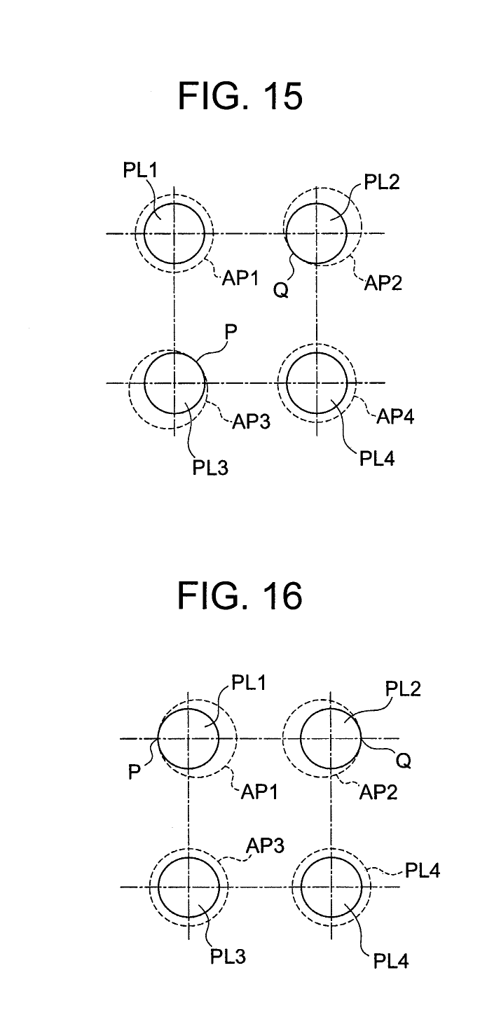

FIGS. 15 and 16 are views each showing a modified example of a position of the aperture abutting on the convex lens unit. In the modified example of FIG. 15, the optical surfaces or the internal sides (proximal sides) of the convex lens units PL2, PL3 abut on edge portions of the apertures AP2, AP3 at the two points P, Q. On the other hand, in the modified example of FIG. 16, the optical surfaces or only the external sides of the convex lens units PL1, PL2 abut on edge portions of the apertures AP1, AP2 at the two points P, Q. The configuration and the operation other than what is described above are the same as those in the examples discussed above.

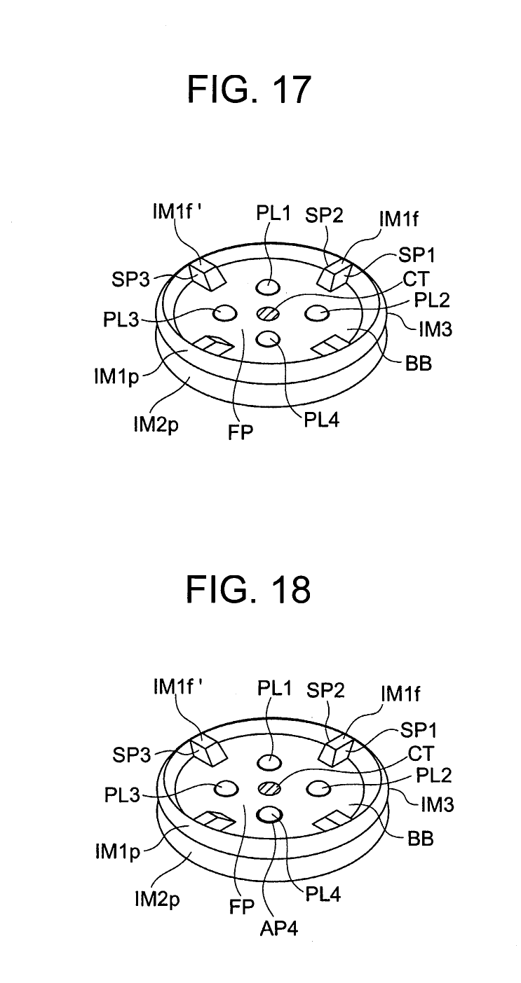

FIG. 17 is a perspective view showing the lens member IM3 according to another embodiment (working example). In this working example, the lens member IM3 and the lens holder LH are positioned in the optical-axis direction by abutting, as described above, the flat surface FP defined as the reference surface on the abutting portion CT, and two of the four convex portions IM1f molded by the die assemblies are positioned in the optical-axis orthogonal direction and around the Z-axis with the rib surface being used as the reference surface. To be specific, the lens member IM3 is abutted on the face-to-face surface of the lens holder LH (see FIG. 11), in which two side surfaces SP1, SP2 of one rib IM1f of the lens member IM3 serve as the reference surfaces. Further, the lens member IM3 is abutted on the face-to-face surface of the lens holder LH, in which one side surface SP3 of a rib IM1f′ distanced through 90 degrees from one rib IM1f serves as the reference surface. Thus, the lens member IM3 is abutted on the face-to-face surface of the lens holder LH. This contrivance enables the positioning in the optical-axis orthogonal direction and around the Z-axis.

Further, in a modified example depicted in FIG. 18, the lens member IM3 and the lens holder LH are positioned in the optical-axis direction by, as described above, abutting the flat surface FP defined as the reference surface on the abutting portion CT; and the one side surface of any one rib of the four convex portions IM1f molded by the die assemblies and the surface of any one of the lens units are used as the reference surfaces for the positioning in the optical-axis orthogonal direction and around the Z-axis. Specifically, the one side surface (which is any one of the side surfaces SP1-SP3) of the single rib of the lens member IM3 abuts on the face-to-face surface of the lens holder LH (see FIG. 11). Moreover, any one (which is herein the convex lens unit PL4) of the convex lens units is abutted on the whole or a part of the periphery of the aperture (which is herein the aperture AP4). With this contrivance, it is feasible to perform the positioning around the Z-axis and in the optical-axis orthogonal direction.

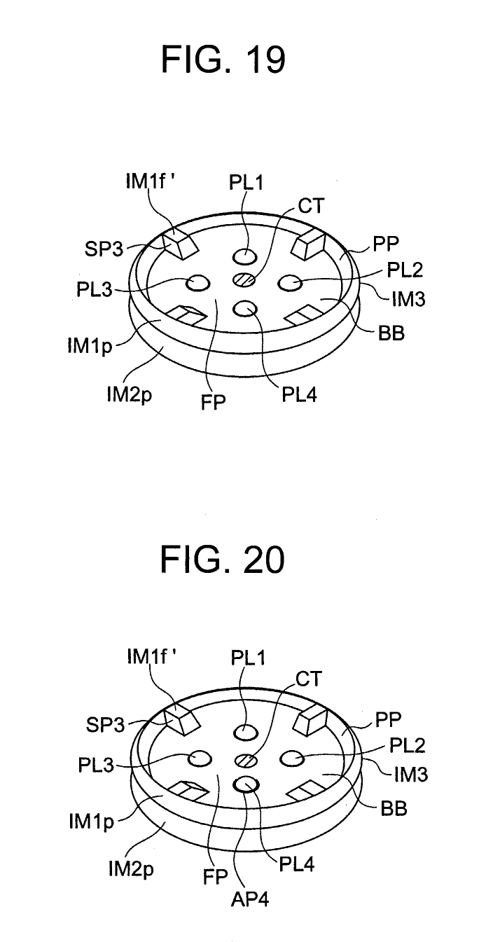

Further, in a modified example illustrated in FIG. 19, the lens member IM3 and the lens holder LH are positioned in the optical-axis direction by, as described above, abutting the flat surface FP defined as the reference surface on the abutting portion CT; and one side surface of any one rib of the four convex portions IM1f molded by the die assemblies and a peripheral surface (which is herein an internal peripheral surface) PP surrounding the convex lens unit molded by the die assemblies are used as the reference surfaces for the positioning in the optical-axis orthogonal direction and around the Z-axis. To be specific, one side surface (which is any one of the side surfaces SP1-SP3) of the single rib of the lens member IM3 abuts on the face-to-face surface of the lens holder LH (see FIG. 11). Moreover, the peripheral surface PP is abutted on the face-to-face surface of the lens holder LH (see FIG. 11). With this contrivance, it is possible to perform the positioning around the Z-axis and in the optical-axis orthogonal direction.

Furthermore, in a modified example illustrated in FIG. 20, the lens member IM3 and the lens holder LH are positioned in the optical-axis direction by, as described above, abutting the flat surface FP defined as the reference surface on the abutting portion CT; and the surface of any one the lens units and the peripheral surface (which is herein the internal peripheral surface) PP surrounding the convex lens unit molded by the die assemblies are employed as the reference surfaces for the positioning in the optical-axis orthogonal direction and around the Z-axis. To be specific, any one (which is herein the convex lens unit PL4) of the convex lens units is abutted on the whole or a part of the periphery of the aperture (which is herein the aperture AP4). Further, the peripheral surface PP is abutted on the face-to-face surface of the lens holder LH (see FIG. 11). With this contrivance, it is feasible to perform the positioning around the Z-axis and in the optical-axis orthogonal direction.

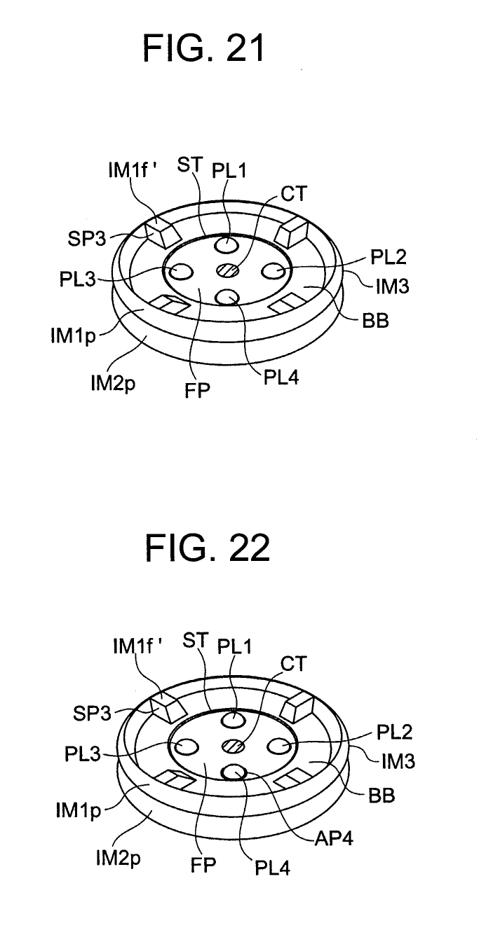

Moreover, in a modified example illustrated in FIG. 21, the lens member IM3 and the lens holder LH are positioned in the optical-axis direction by, as described above, abutting the flat surface FP defined as the reference surface on the abutting portion CT; and one side surface of any one rib of the four convex portions IM1f molded by the die assemblies and a stepped surface ST surrounding the convex lens unit inwardly of the convex portion IM1f molded by the die assemblies are used as the reference surfaces for the positioning in the optical-axis orthogonal direction and around the Z-axis. The stepped surface ST can be molded by the die assemblies so as to be lowered by one step from the periphery thereof. To be specific, one side surface (which is any one of the side surfaces SP1-SP3) of the single rib of the lens member IM3 abuts on the face-to-face surface of the lens holder LH (see FIG. 11). Moreover, with the stepped surface ST serving as the reference surface, the lens member IM3 is abutted on the face-to-face surface of the lens holder LH (see FIG. 11). With this contrivance, it is possible to perform the positioning around the Z-axis and in the optical-axis orthogonal direction.

Further, in a modified example illustrated in FIG. 22, the lens member IM3 and the lens holder LH are positioned in the optical-axis direction by, as described above, abutting the flat surface FP defined as the reference surface on the abutting portion CT; and the surface of any one of the lens units and the stepped surface ST surrounding the convex lens unit inwardly of the convex portion IM1f molded by the die assemblies are used as the reference surfaces for the positioning in the optical-axis orthogonal direction and around the Z-axis. Specifically, any one (which is herein the convex lens unit PL4) of the convex lens units is abutted on the whole or a part of the periphery of the aperture (which is herein the aperture AP4). Further, with the stepped surface ST serving as the reference surface, the lens member IM3 is abutted on the face-to-face surface of the lens holder LH (see FIG. 11). With this contrivance, it is possible to perform the positioning around the Z-axis and in the optical-axis orthogonal direction. Moreover, the peripheral surface PP and the stepped surface ST are employed as the reference surfaces, in which case these surfaces, if being inclined surfaces having as high accuracy as 45 degrees etc, may be used for the positioning in the optical-axis direction.

According to the working example discussed above, the lens member is configured to include the lens units having the 2 lens elements and may also be configured to include the lens unit having one lens element. In such a case, the bonding steps shown in FIGS. 8-10 become unnecessary. The highly accurate positioning can be attained by combining the surfaces of the lens units, the surfaces of the ribs, the peripheral surface and the stepped surface of which any one or more serve as the reference surfaces.

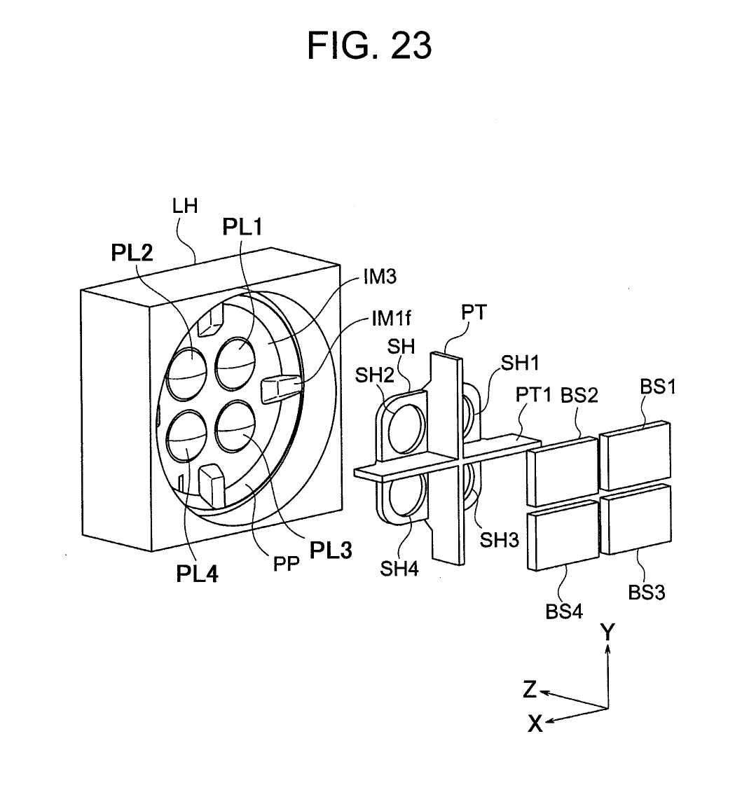

FIG. 23 is an exploded view of a compound-eye image capturing apparatus according to still another working example as viewed from the image side. In the present working example, the apparatus is configured by, similarly to the working examples discussed above, further fitting a partitioning member PT to the lens member IM3 fitted to the lens holder LH. The partitioning member PT is built up to include a main body PT1 constructed by fabricating plate members in a cross shape, and a rectangular thin-plate light shielding member SH bonded to the object side of the main body PT1. The light shielding member SH for preventing a ghost has apertures SH1-SH4 corresponding to the convex lens units PL1-PL4. The main body PT1 has four quadrants to which rectangular base plates BS1-BS4 with image capturing elements being formed on the object side are bonded in the way of being orthogonal to the optical axis. Further, the image capturing elements may not be separated individually but may be assembled into one single image capturing element. In such a case, image processing is applied to image signals that are output from the single image capturing element, thereby enabling the image signals to be separated into four frames of images. The positioning with respect to the image capturing element(s) in the optical-axis direction may be attained by making use of the bottom face of the lens holder LH and also by making use of the bottom face of the partitioning member PT.

According to the present working example, in the same way as in the mode of FIG. 13, the two optical surfaces or peripheral surfaces of the convex lens units PL1-PL4 of the lens member IM3 serve as the reference surfaces, in which the lens member IM3 and the partitioning member PT are positioned in the optical-axis direction and around the Z-axis by abutting on the two of the apertures SH1-SH4 at the two points. Hence, the convex lens units PL1-PL4 and the apertures SH1-SH4 of the light shielding member SH are positioned with the high accuracy, and the convex lens units PL1-PL4 and the base plates BS1-BS4, i.e., the image capturing elements are positioned with the high precision via the main body PT1 of the partitioning member PT. The positioning described above is acceptable, and the bottom face (image-side face) of the lens holder LH and the image capturing element may also be positioned with a clearance provided between the partitioning member PT and the image capturing element. Note that the reference surfaces may involve, without being limited to the surfaces of the convex lens units PL1-PL4, using the surface of the rib IM1f, the peripheral surface PP, the stepped surface, etc.

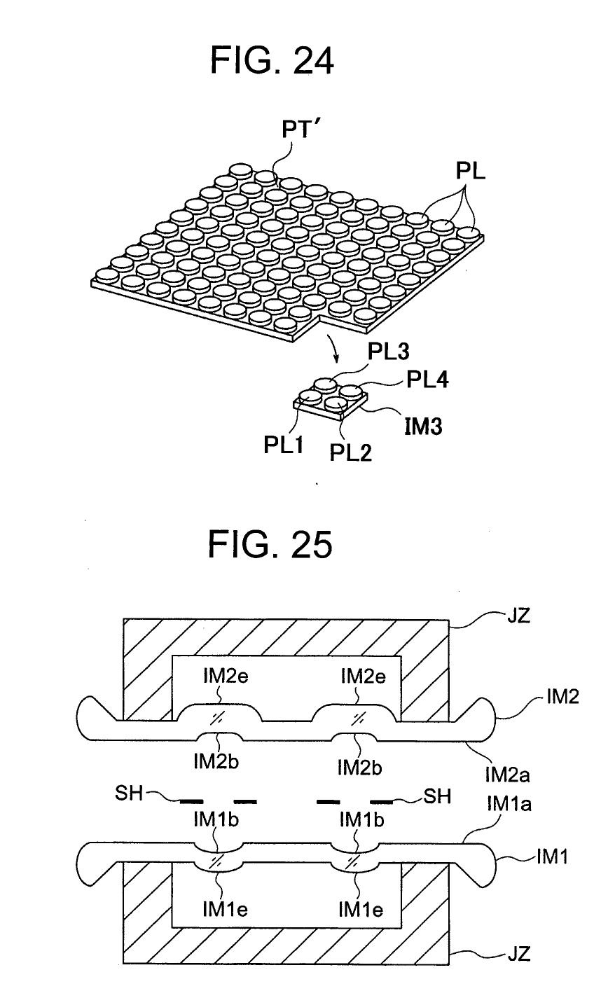

FIG. 24 is a view showing a part of steps of manufacturing the lens member according to yet another working example. As illustrated in FIG. 24, the lens member IM3 is configured by molding a multiplicity of lens units PL in matrix on a single base plate PT′ by use of the die assemblies and thereafter cutting out the base plate PT′ in a way that embraces a predetermined number (four pieces herein) of lens units PL1-PL4. The lens member IM3 is fitted or assembled in the same way as in the case of the glass lens member described above.

### Second Embodiment

A second embodiment of the present invention will hereinafter be described with reference to FIGS. 25-42.

A description of how the image capturing lens is manufactured will be made. Similarly to FIGS. 1-7 given above, the first glass lens array IM1 and the second glass lens array IM2 can be configured. Next, similarly to FIG. 8, the relative positions of the two jigs JZ are determined with the high accuracy, whereby the first glass lens array IM1 and the second glass lens array IM2 can be positioned with the high accuracy.

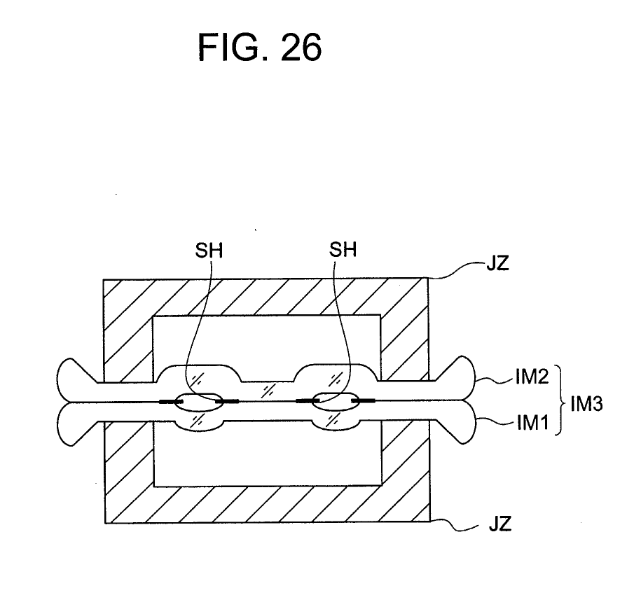

Next, as depicted in FIG. 25, the surface IM1a of the first glass lens array IM1 held by the jig JZ with the high precision as described above is set in the face-to-face relationship with the surface IM2a of the second glass lens array IM2 held by another jig JZ with the high accuracy. Then, the bonding agent is applied over at least one of the surfaces IM1a, IM2a of the first glass lens array IM1 and the second glass lens array IM2. Thereafter, as illustrated in FIG. 26, the surfaces IM1a and IM2a are tightly fitted together by relatively getting the jigs JZ close to each other, and the bonding agent waits being solidified. With the bonding agent being solidified, the third glass lens array IM3 is configured by the first glass lens array IM1 and the second glass lens array IM2 being bonded together.

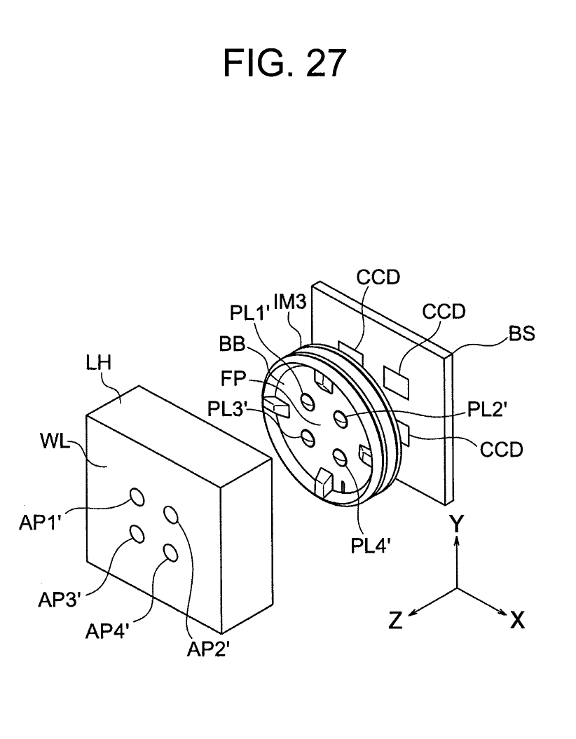

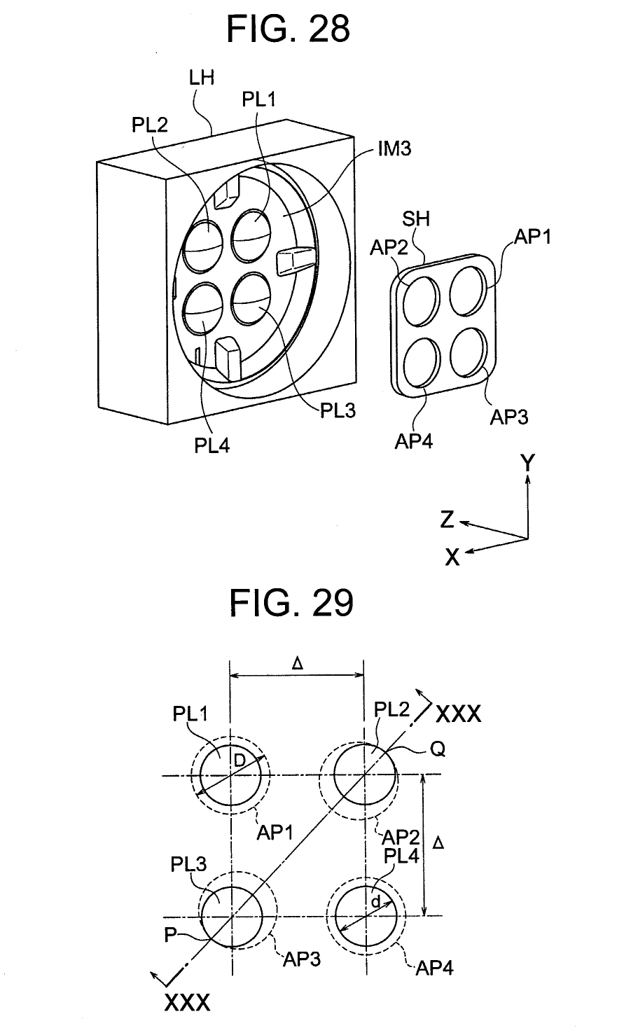

Thereafter, the upper jig JZ stops sucking, and the upper and lower jigs JZ are thus separated from each other, whereby the third glass lens array IM3 held by the lower jig JZ can be taken out. This third glass lens array IM3 is called the lens member, in which four pieces of object-side lens units denoted by PL1′-PL4′ and taking the same shape are formed within the lens member IM3 (see FIG. 27), and four pieces of image-side convex lens units taking the same shape are denoted by PL1-PL4 (see FIG. 28). Moreover, the flat surface FP of the base plate BB is defined as an optical-axis orthogonal surface extending along the peripheries of the convex lens units PL1-PL4. The optical surfaces or the peripheral surfaces of the convex lens units PL1-PL4 and the flat surface FP are each formed with the high accuracy by the die assemblies and herein configure the reference surfaces.

Next, a method of assembling a compound-eye image capturing apparatus including compound-eye units according to the present embodiment will be described. FIG. 27 is an exploded view of the compound-eye image capturing apparatus as viewed from the object side. The lens holder LH taking the hollowed angular cylindrical shape is opened on the image side but closed as the wall WL on the object side as illustrated in FIG. 27. The wall WL is formed with the four apertures AP1-AP4 and the abutting portion CT (unillustrated) protruding on the image side between the apertures. The apertures AP1′-AP4′ are disposed in (2-column×2-row) matrix corresponding to the convex lens units PL1′-PL4′ of the lens member IM3. After inserting, positioning and fixing the lens member IM3 within the lens holder LH, the image capturing elements CCD (Charge Coupled Device) are disposed in (2-column×2-row) matrix corresponding to the convex lens units PL at the image-side open end of the lens holder LH on the base plate BB, and the compound-eye image capturing apparatus is configured by fitting this base plate BB. Herein, the Z-direction is defined as the optical-axis direction, while the X-direction and the Y-direction are defined as the optical-axis orthogonal directions.

FIG. 28 is an exploded view of the compound-eye image capturing apparatus as viewed from the image side, in which the bottom plate is omitted. In FIG. 28, the apparatus is configured by further fitting the light shielding member SH to the lens member IM3 fitted to the lens holder LH. The light shielding member SH for preventing the ghost has the apertures AP1-AP4 corresponding to the convex lens units PL1-PL4.

Next, a method of how the light shielding member SH is positioned to the lens member IM3 will be described. FIG. 29 is a view showing a positional relationship between the convex lens units PL1-PL4 (depicted by the solid lines) of the lens member IM3 and the apertures AP1-AP4 (depicted by the dotted lines) of the light shielding member SH as viewed from the Z-direction. As apparent from FIG. 29, there is the fixed interval Δ between the optical axes of the convex lens units PL1-PL4 adjacent to each other lengthwise and crosswise. On the other hand, the inside diameter D of each of the apertures AP1-AP4 is set larger than the outside diameter d of each of the convex lens units PL1-PL4, the centers of the apertures AP1 and AP4 are coincident with the optical axes of the convex lens units PL1 and PL4, however, the centers of the apertures AP2 and AP3 are shifted inward from the optical axes of the convex lens units PL2 and PL3.

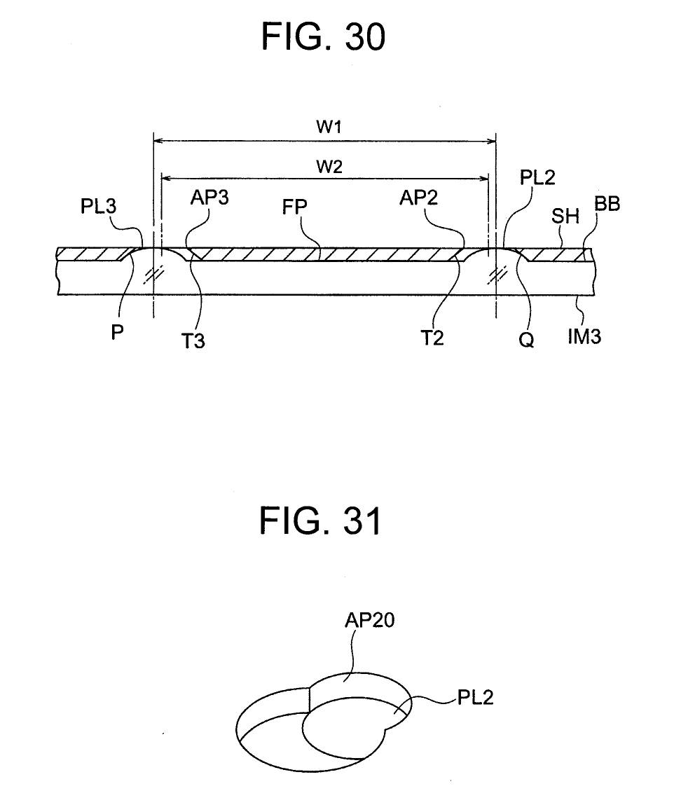

FIG. 30 is a view of a configuration cut off along a line XXX-XXX in FIG. 29 as viewed in an arrow direction. Internal peripheries of the aperture AP2, AP3 of the light shielding member SH are formed with tapered surfaces T2, T3 with their diameters being reduced as getting away from the lens member IM3. The distance W2 between the centers of the apertures AP2, AP3 shifted inward is smaller than the distance W1 between the optical axes of the convex lens units PL2, PL3, and hence, when the lens member IM3 is made to approach the light shielding member SH along the optical-axis direction, as illustrated in FIG. 30, the surface of the light shielding member SH abuts on the flat surface FP. At this time, however, the optical surfaces of the convex lens units PL2, PL3 or the external portions (distant portions) of the peripheral surfaces thereof abut on the tapered surfaces T2, T3 of the apertures AP2, AP3 at two points P, Q, whereby the lens member IM3 and the light shielding member SH are positioned in the optical-axis orthogonal directions and around the Z-axis. With this contrivance, it is feasible not to abut the lower edges of the apertures AP2, AP3 on boundaries between the flat surface FP and the convex lens units PL2, PL3. The convex lens units PL1, PL4 do not, however, abut on the apertures AP1, AP4 and therefore hinder none of the positioning. With the contrivance described above, the light shielding member SH can be positioned to the lens member IM3 with the high precision, and hence it follows that these two members are fixed by the bonding agent etc in this state. Incidentally, it is preferable that the peripheral surfaces rather than the optical surfaces abut on the apertures.

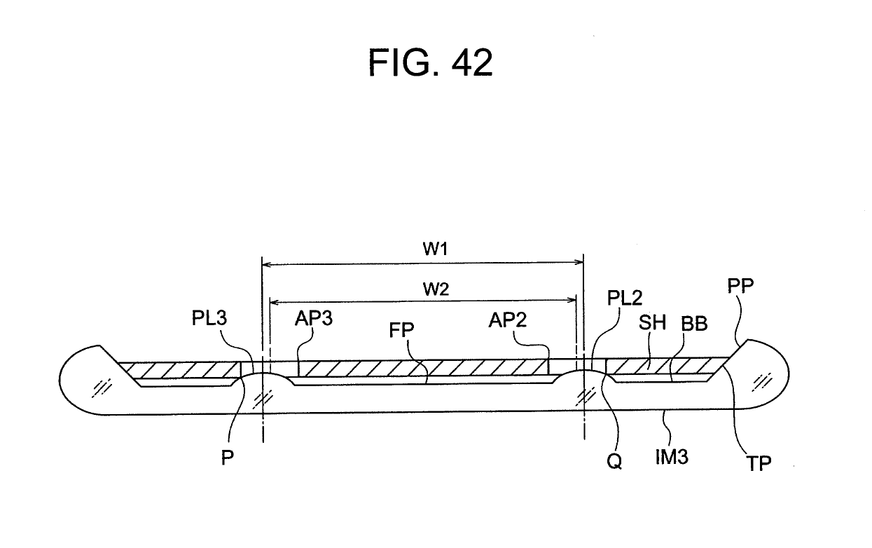

FIG. 42 is a sectional view similar to FIG. 30 according to another working example. In the present working example, the peripheral surface PP molded by the die assemblies and inclined at 45 degrees to the optical axis serves as the reference surface, and is abutted on a peripheral edge TP (it is preferable if inclined at 45 degrees corresponding thereto) of the light shielding member SH, thereby performing the positioning in the optical-axis direction and in the optical-axis orthogonal direction. Moreover, the optical surfaces or the external sides (distant sides) of the peripheral surfaces of the convex lens units PL2, PL3 abut on the apertures AP2, AP3 (the cylindrical internal peripheral surfaces in the present working example) at the two points P, Q, whereby the lens member IM3 and the light shielding member SH are positioned around the Z-axis. Note that the same stepped surface (unillustrated) is provided between the peripheral surface PP and the lens unit, and the peripheral edge TP of the light shielding member SH may also undergo abutting.

FIG. 31 is a view illustrating a modified example of the shape of the aperture. An aperture AP20 illustrated in FIG. 31 takes a double semicircular shape formed by combining a large circle and a small circle, in which the positioning is attained by fitting the small circle of the aperture AP20 to the convex lens unit PL2. The aperture may, without being limited to this shape, take a shape formed so as to abut the two straight sides forming an arbitrary aperture on the optical surfaces or the peripheral surfaces of the convex lens units.

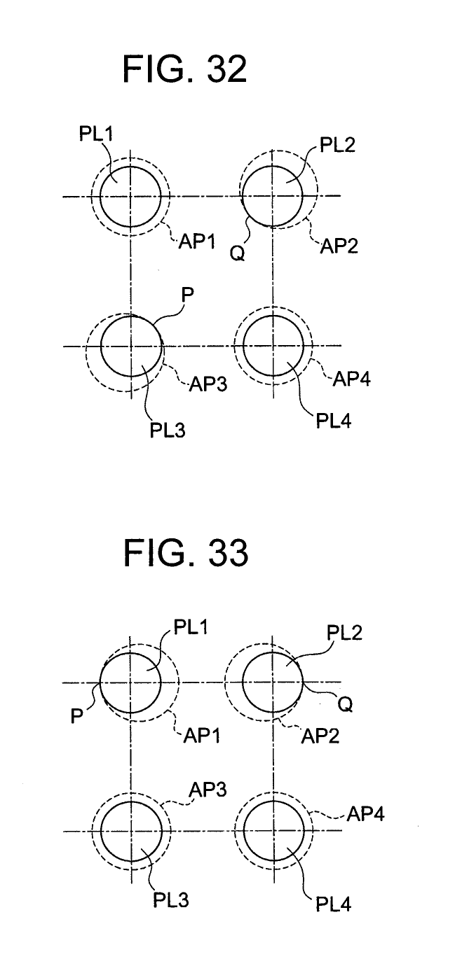

FIGS. 32 and 33 are views each illustrating a modified example of the position of the aperture abutting on the convex lens unit. In the modified example of FIG. 32, the optical surfaces or the internal sides (proximal sides) of the convex lens units PL2, PL3 abut on the edge portions of the apertures AP2, AP3 at the two points P, Q. On the other hand, in the modified example of FIG. 33, only the optical surfaces or the external sides of the convex lens units PL1, PL2 abut on the edge portions of the apertures AP1, AP2 at the two points P, Q. The configuration and the operation other than what is described above are the same as those in the examples described above.

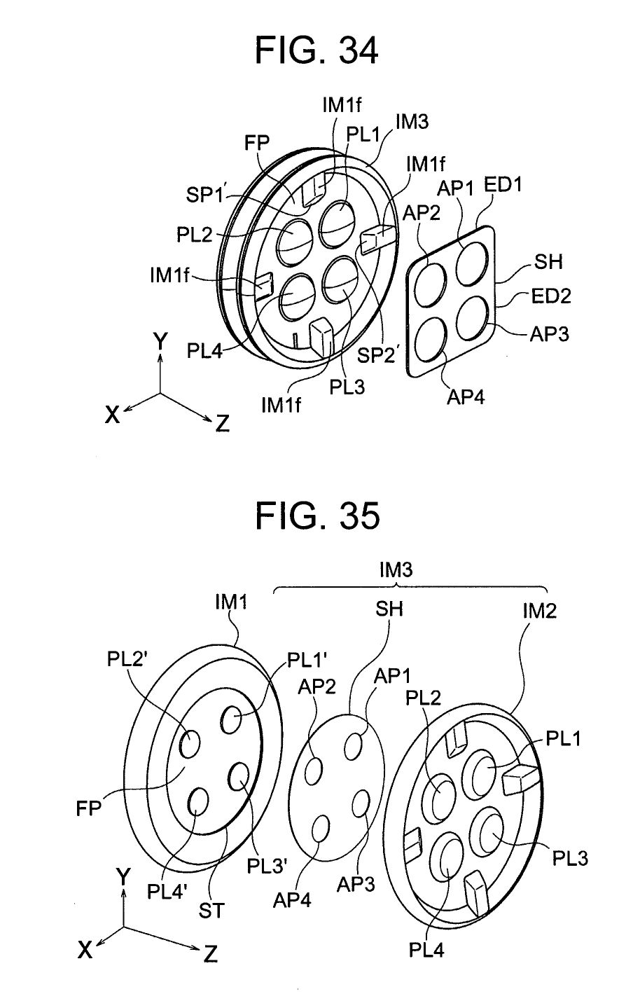

FIG. 34 is an exploded view of the lens member IM3 and the light shielding member SH according to another working example. In the present working example, two or more of the four convex portions IM1f molded by the die assemblies are used as the ribs for the reference surfaces. To be specific, internal peripheral surfaces SP1′, SP2′ of the two ribs IM1f, distanced through 90 degrees from each other, of the lens member IM3 serve as the reference surfaces, and edge portions ED1, ED2 of the two intersecting sides of the light shielding member SH are made to abut thereon. With this contrivance, the lens member IM3 and the light shielding member SH can be positioned in the optical-axis orthogonal direction and around the Z-axis. Furthermore, the lens member IM3 and the light shielding member SH can be positioned in the optical-axis direction by tightly fitting the light shielding member SH to the flat surface FP of the lens member IM3. Note that the four sides of the light shielding member SH may also be abutted on the internal peripheral surfaces of the four ribs IM1f.

FIG. 35 is an exploded view of the lens member IM3 and the light shielding member SH according to still another working example. In the present working example, the light shielding member SH is disposed integrally between the first lens member IM1 and the second lens member IM2, which are constructed by the manufacturing steps described above. This operation can be performed during the steps in FIGS. 25 and 10. In the present working example, the light shielding member SH takes the disc shape, and the stepped surface ST (e.g., the tapered surface inclined at 45 degrees to the optical axis) formed by the die assemblies along the peripheries of the convex lens units PL1′-PL4′, and the flat surface FP is formed in the way of being lowered by one step from the peripheries of the convex lens units PL1′-PL4′.

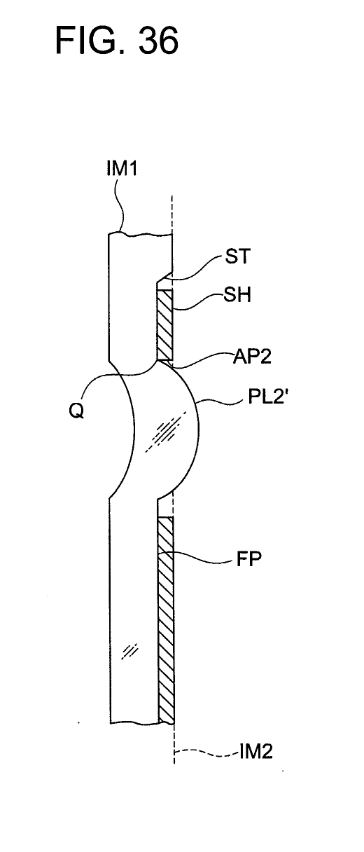

FIG. 36 is a sectional view of the lens member IM1 and the light shielding member SH in an assembled state. As illustrated in FIG. 36, in the assembled state, the two apertures AP2 (only one aperture is depicted) of the light shielding member SH abut on the optical surfaces or the peripheral surfaces of the corresponding convex lens units PL2′ (only one lens unit is illustrated) at the two points P, Q, thereby conducting the positioning in the optical-axis orthogonal direction and around the Z-axis. On the other hand, the face-to-face surfaces of the first and second lens members IM1, IM2 are tightly fitted together by getting the second lens member IM2 to approach a position indicated by a dotted line, whereby the light shielding member SH can be positioned in the optical-axis direction while being sandwiched from both sides in the state of abutting on the flat surface FP. Note that the first lens member IM1 and the light shielding member SH may be positioned by abutting the external periphery of the light shielding member SH with the stepped surface ST serving as the reference surface. The light shielding member SH can be also fitted in the same mode to the second lens member IM2 in place of the first lens member IM1.

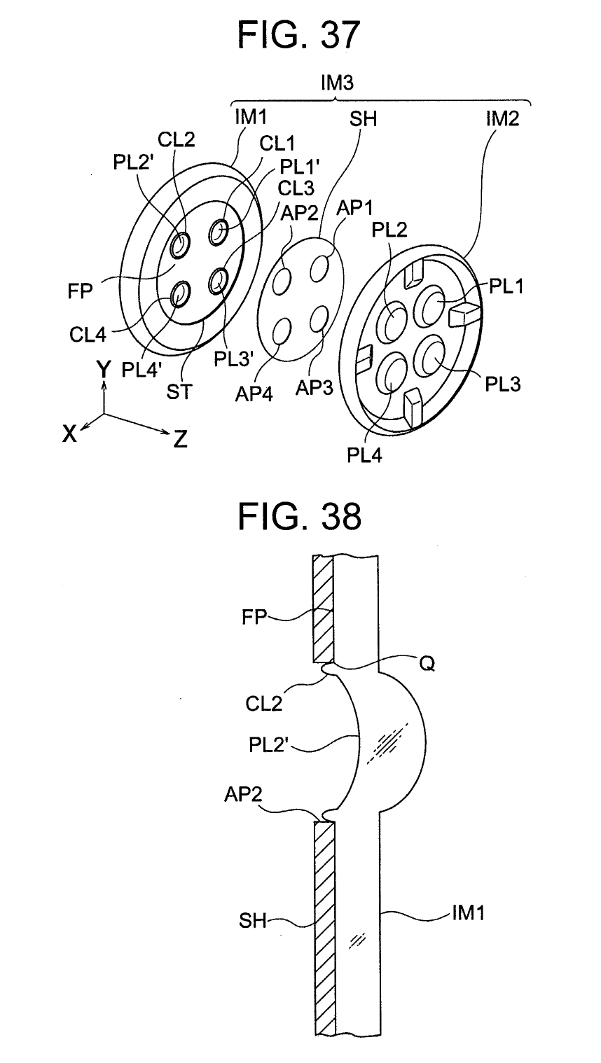

Described next is a case where the lens unit provided with the light shielding member SH is a concave lens unit. FIG. 37 is an exploded view of the lens member IM3 and the light shielding member SH according to yet another working example. In the present working example, by contrast with the working example in FIG. 35, the first lens member IM1 is formed with four concave lens units PL1′-PL4′, and protruded portions swelled out along the respective concave lens units PL1′-PL4′ configure annular portions CL1-CL4.

FIG. 38 is a sectional view of the lens member IM1 and the light shielding member SH in the assembled state. As illustrated in FIG. 38, in the assembled state, the two apertures AP2 (only one aperture is depicted) of the light shielding member SH abut at two points Q (only one point is illustrated) on the periphery of the annular portion CL2 extending along the circumference of the concave lens unit PL2′ recessed in a concave shape on the side of the light shielding member corresponding to the aperture, thereby performing the positioning in the optical-axis orthogonal direction and around the Z-axis. Similarly to the working examples described above, the first lens member IM1 and the second lens member IM2 are tightly fitted together, whereby the light shielding member SH can be positioned in the optical-axis direction while being sandwiched from both sides in the state of abutting on the flat surface FP. Incidentally, it is sufficient that the annular portions are provided along the peripheries of only the two lens units on which the apertures of the light shielding member are abutted.

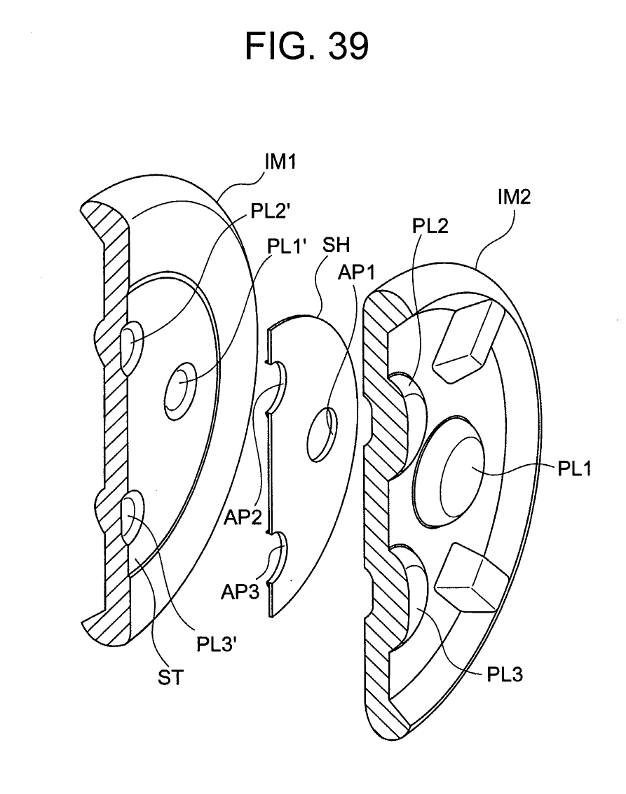

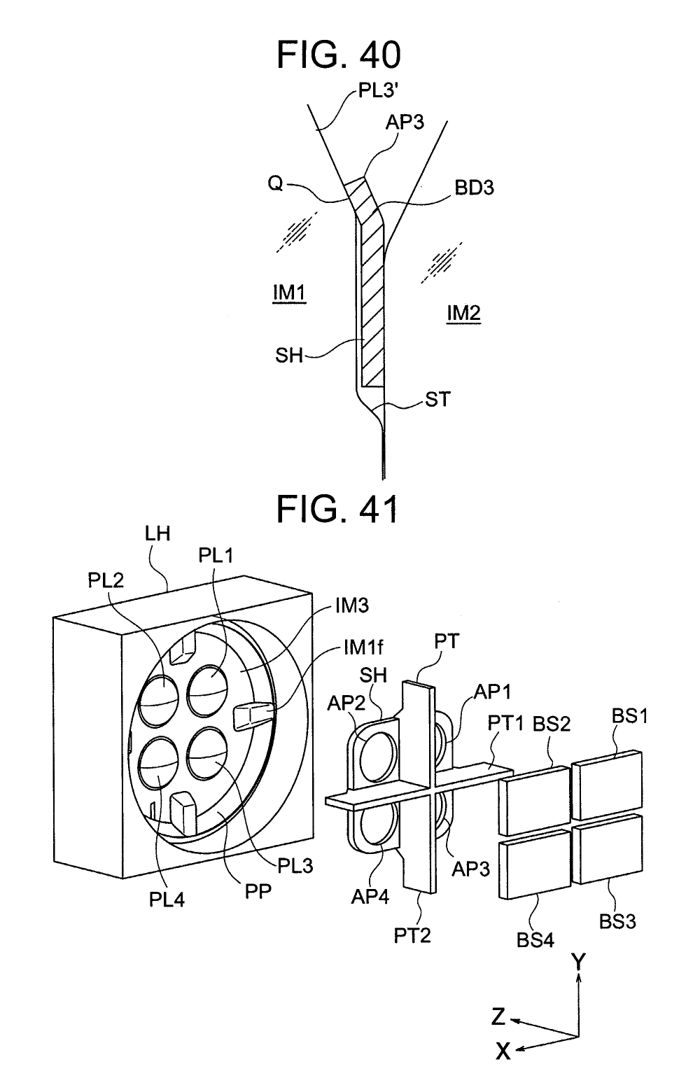

FIG. 39 is an exploded sectional view according to still yet another working example, and FIG. 40 is a sectional view of a portion in the vicinity of the aperture of the light shielding member. The present working example is preferable to a case where the annular portion is not desired to be provided along the periphery of the lens unit in the manner described above. The light shielding member SH is composed of a metal plate, and a tapered portion BD3 serving as the protruded portion is configured by folding the peripheral portion of each of the two apertures AP3 (only one aperture is depicted) with a press so as to fall down toward the corresponding concave lens unit PL3′. Further, the light shielding member SH is manufactured by molding, and on this occasion the protruded potion may also be molded simultaneously. Moreover, the protruded portions may be manufactured separately and bonded together. In the present working example, in the assembled state, the two tapered portions BD3 (only one portion is illustrated) of the light shielding member SH abut on the optical surfaces or the peripheral surfaces of the corresponding concave lens units PL3′ at the two points Q (only one point is depicted), thereby enabling the positioning in the optical-axis orthogonal direction and around the Z-axis. The configuration other than what is described above is the same as those in the working examples discussed above.

In the working examples described above, the lens member is configured to include the lens units having the 2 lens elements and may also be configured to include the lens unit having one lens element. In such a case, the bonding steps shown in FIGS. 8, 25 and 26 become unnecessary. The highly accurate positioning can be thus attained by combining the surfaces of the lens units, the surfaces of the ribs, the peripheral surface and the stepped surface of which any one or more serve as the reference surfaces.

FIG. 41 is an exploded view of the compound-eye image capturing apparatus as viewed from the image side according to a further working example. In the present working example, similarly to the working examples discussed above, the apparatus is configured by further fitting the partitioning member PT to the lens member IM3 fitted to the lens holder LH. The partitioning member PT is built up to include the main body PT1 constructed by fabricating the plate members in the cross shape, and the rectangular thin-plate light shielding member SH bonded to the object side of the main body PT1. The light shielding member SH for preventing the ghost has the apertures AP1-AP4 corresponding to the convex lens units PL1-PL4. The main body PT1 has the four quadrants to which the rectangular base plates BS1-BS4 with the image capturing elements being formed on the object side are bonded in the way of being orthogonal to the optical axis. Further, the image capturing elements may not be separated individually but may be assembled into one single image capturing element. In such a case, the image processing is applied to the image signals that are output from the single image capturing element, thereby enabling the image signals to be separated into the four frames of images. The positioning with respect to the image capturing element(s) in the optical-axis direction may be attained by making use of the bottom face of the lens holder LH and also by making use of the bottom face of the partitioning member PT.

According to the present working example, in the same way as in the mode of FIG. 30, the two optical surfaces or peripheral surfaces of the convex lens units PL1-PL4 of the lens member IM3 serve as the reference surfaces, in which the lens member IM3 and the partitioning member PT are positioned in the optical-axis orthogonal direction and around the Z-axis by abutting on the two of the apertures AP1-AP4 at the two points. Hence, the convex lens units PL1-PL4 and the apertures AP1-AP4 of the light shielding member SH are positioned with the high accuracy, and the convex lens units PL1-PL4 and the base plates BS1-BS4, i.e., the image capturing elements are positioned with the high precision via the main body PT1 of the partitioning member PT. The positioning described above is acceptable, and the bottom face (image-side face) of the lens holder LH and the image capturing element may also be positioned with the clearance provided between the partitioning member PT and the image capturing element. Note that the reference surfaces may involve, without being limited to the surfaces of the convex lens units PL1-PL4, using the surface of the rib IM1f, the peripheral surface PP, the stepped surface, etc.

Further, similarly to FIG. 24, the lens member IM3 in the present working example is configured by molding the multiplicity of lens units PL in matrix on the single base plate PT′ by use of the die assemblies and thereafter cutting out the base plate PT′ in a way that embraces the predetermined number (four pieces herein) of lens units PL1-PL4. The lens member IM3 is fitted or assembled in the same way as in the case of the glass lens member described above.

### INDUSTRIAL APPLICABILITY

It is apparent to those skilled in the art from the embodiments and the technical ideas described in the present specification that the present invention is not limited to the embodiments described in the specification but embraces other embodiments and modified examples.

### REFERENCE SIGNS LIST

11 core support member
12 upper die assembly
12a aperture
12b undersurface
13 core
13a transfer surface
21 core support member
22 lower die assembly
22a aperture
22b upper surface
22e groove
22g tapered portion
12 core
23a transfer surface
AP1-AP4 aperture
BS bottom plate
CCD image capturing element
CT abutting portion
FP flat surface
IM1 glass lens array
IM1f, IM1f′ rib
IM2 glass lens array
IM3 glass lens array (lens member)
JZ jig
JZx reference holding surface
JZy reference holding surface
LH lens holder
NZ platinum nozzle
PL1-PL4 convex lens unit
PP peripheral surface
SP1, SP2 both side surface
SP one side surface
SPx spring
Spy spring
ST stepped surface
CL1-CL4 annular portion
ED1, ED2 edge portion
PL1′-PL4′ convex lens unit or concave lens unit
SP1′, SP2′ internal peripheral surface

1. A compound-eye unit comprising:
a lens member being molded by die assemblies and formed with a plurality of lens units in a predetermined positional relationship; and
a lens holder being provided with a plurality of apertures corresponding to the lens units,
wherein a surface of the lens member including the plurality of lens units molded by the die assemblies is set as a reference surface of the lens member that specifies at least one of an optical-axis direction relative position, an optical-axis orthogonal direction relative position and a rotating direction relative position between the lens member and the lens holder.

2. The compound-eye unit according to claim 1, wherein curved surfaces of the two of the plurality of lens units are set as the reference surfaces.

3. The compound-eye unit according to claim 2, wherein the two convex lens units abut on the apertures of the lens holder in such a way that sides, distant from each other, of the optical surfaces or sides, distant from each other, of the peripheral surfaces are set as the reference surfaces.

4. The compound-eye unit according to claim 2, wherein the two convex lens units abut on the apertures of the lens holder in such a way that sides, proximal to each other, of the optical surfaces or sides, proximal to each other, of the peripheral surfaces are set as the reference surfaces.

5. The compound-eye unit according to claim 3, wherein the optical surfaces or the peripheral surfaces of the lens units other than the two convex lens units are prevented from abutting on the apertures of the lens holder.

6. The compound-eye unit according to claim 2, wherein the two convex lens units are the lens units of which optical axes are distanced to the greatest degree within the plurality of lens units.

7. The compound-eye unit according to claim 1, wherein the lens member includes one or more ribs on the surface of the lens member molded by die assemblies, and
with the rib surface serving as the reference surface, the lens member is abutted on a part of the lens holder.

8. The compound-eye unit according to claim 1, wherein the lens member includes peripheral surfaces surrounding the plurality of lens units molded by the die assemblies, and
with the peripheral surfaces serving as the reference surfaces, the lens member is abutted on a part of the lens holder.

9. The compound-eye unit according to claim 1, wherein the lens member includes a stepped surface defined as the surface of the lens member molded by the die assemblies and formed along peripheries of the plurality of lens units, and
with the stepped surface serving as the reference surface, the lens member is abutted on a part of the lens holder.

10. The compound-eye unit according to claim 1, wherein the die assemblies molding the lens member do not restrict an external periphery of the lens member when molding, and
the lens member is a glass.

11. The compound-eye unit according to claim 1, wherein the lens member includes a substrate, and
the lens units are formed on at least one surface of the substrate.

12. The compound-eye unit according to claim 1, wherein the lens member is acquired by forming a multiplicity of lens units on one substrate and thereafter cutting out the substrate so as to embrace a predetermined number of lens units.

13. The compound-eye unit according to claim 1, wherein a surface molded by the die assemblies is set as the reference surface for positioning a light shielding member disposed adjacent to the lens unit.

14. The compound-eye unit according to claim 1, wherein the surface molded by the die assemblies is set as the reference surface for positioning an image capturing element.

15. A compound-eye unit comprising:
a lens member being molded by die assemblies and formed with a plurality of lens units in a predetermined positional relationship; and
a light shielding member being provided with a plurality of apertures corresponding to the lens units,
wherein a surface of the lens member including the plurality of lens units molded by the die assemblies is set as a reference surface of the lens member that specifies at least one of an optical-axis direction relative position, an optical-axis orthogonal direction relative position and a rotating direction relative position between the lens member and the light shielding member.

16. The compound-eye unit according to claim 15, wherein curved surfaces of the two of the plurality of lens units are set as the reference surfaces.

17. The compound-eye unit according to claim 16, wherein the two convex lens units abut on the apertures of the light shielding member in such a way that sides, distant from each other, of the optical surfaces or sides, distant from each other, of the peripheral surfaces are set as the reference surfaces.

18. The compound-eye unit according to claim 16, wherein the two convex lens units abut on the apertures of the light shielding member in such a way that sides, proximal to each other, of the optical surfaces or sides, proximal to each other, of the peripheral surfaces are set as the reference surfaces.

19. The compound-eye unit according to claim 17, wherein the optical surfaces or the peripheral surfaces of the lens units other than the two convex lens units are prevented from abutting on the apertures of the light shielding member.

20. The compound-eye unit according to claim 16, wherein the two convex lens units are the lens units of which optical axes are distanced to the greatest degree within the plurality of lens units.

21. The compound-eye unit according to claim 15, wherein curved surfaces of two concave lens units of the plurality of lens units are set as the reference surfaces,
at least apart of the aperture of the light shielding member is provided with a protruded portion, and
the protruded portion is abutted on the reference surface.

22. The compound-eye unit according to claim 15, wherein a stepped surface is provided on the surface of the lens member formed by the die assemblies outwardly of the lens units and is set as the reference surface.

23. The compound-eye unit according to claim 15, wherein a projection is provided on the surface of the lens member formed by the die assemblies outwardly of the lens units, and a side surface of the projection is set as the reference surface.

24. The compound-eye unit according to claim 15, wherein the lens member includes a rib on the surface of the lens member molded by the die assemblies, and
with the rib surface serving as the reference surface, the lens member is abutted on a part of the light shielding member.

25. The compound-eye unit according to claim 15, wherein the light shielding member is disposed between the plural lens members.

26. The compound-eye unit according to claim 15, wherein the die assemblies molding the lens member do not restrict a periphery of the lens member, and
the lens member is a glass.

27. The compound-eye unit according to claim 15, wherein the surface molded by the die assemblies is set as the reference surface for positioning an image capturing element.

28. The compound-eye unit according to claim 1, wherein the lens member includes a substrate, and
the lens units are formed on at least one surface of the substrate.
